(19) United States
(12) Patent Application Publication
(10) Pub. No.: US 2017/0236132 A1
(43) Pub. Date: Aug. 17, 2017

(54) AUTOMATICALLY MODELING OR SIMULATING INDICATIONS OF INTEREST

(71) Applicant: SAS Institute Inc., Cary, NC (US)

(72) Inventors: CHRISTIAN HAXHOLDT, Cary, NC (US); COBEY LYNN ABRAMOWSKI, Raleigh, NC (US); CHRISTOPHER RAYMOND HOUCK, Cary, NC (US); BENJAMIN ALAN PERRYMAN, Raleigh, NC (US)

(73) Assignee: SAS Institute Inc., Cary, NC (US)

(21) Appl. No.: 15/348,276

(22) Filed: Nov. 10, 2016

Related U.S. Application Data
(60) Provisional application No. 62/294,656, filed on Feb. 12, 2016.

(51) Int. Cl. G06Q 30/02; G06N 5/02

(52) U.S. Cl. CPC G06Q 30/0201; G06N 5/022

(57) ABSTRACT

Indications of interest can be automatically generated. For example, attributes of an item can be received. There can be little or no historical data for the item. Multiple time series associated with other items can also be received. A first set of classifiers can identify a subset of magnitude-pattern groups based on the attributes. A first ensemble methodology can select a final magnitude-pattern group for the item from among the subset of magnitude-pattern groups. A second set of classifiers can determine a subset of interest volumes based on the attributes. A second ensemble methodology can select a final interest volume for the item from among the subset of interest volumes. Interest data can be generated based on the final magnitude-pattern group and the final interest volume. The interest data can provide an initial indication of interest in the item over a future time period.

### REFERENCE TO RELATED APPLICATION

This claims the benefit of priority under 35 U.S.C. §119(e) to U.S. Provisional Patent Application No. 62/294,656, filed Feb. 12, 2016, the entirety of which is hereby incorporated by reference herein.

### BRIEF DESCRIPTION OF THE DRAWINGS

The present disclosure is described in conjunction with the appended figures:

FIG. 1 is a block diagram of an example of the hardware components of a computing system according to some aspects.

FIG. 2 is an example of devices that can communicate with each other over an exchange system and via a network according to some aspects.

FIG. 3 is a block diagram of a model of an example of a communications protocol system according to some aspects.

FIG. 4 is a hierarchical diagram of an example of a communications grid computing system including a variety of control and worker nodes according to some aspects.

FIG. 5 is a flow chart of an example of a process for adjusting a communications grid or a work project in a communications grid after a failure of a node according to some aspects.

FIG. 6 is a block diagram of a portion of a communications grid computing system including a control node and a worker node according to some aspects.

FIG. 7 is a flow chart of an example of a process for executing a data analysis or processing project according to some aspects.

FIG. 8 is a block diagram including components of an Event Stream Processing Engine (ESPE) according to some aspects.

FIG. 9 is a flow chart of an example of a process including operations performed by an event stream processing engine according to some aspects.

FIG. 10 is a block diagram of an ESP system interfacing between a publishing device and multiple event subscribing devices according to some aspects.

FIG. 11 is a flow chart of an example of a process for tuning a system for use in automatically generating indications of interest according to some aspects.

FIG. 12 is a graph of an example of a time series according to some aspects.

FIG. 13 is a flow chart of an example of a process for pre-processing time series data according to some aspects.

FIG. 14 is a flow chart of an example of a process for automatically generating indications of interest according to some aspects.

FIG. 15 is a flow chart of an example of a process for automatically generating an indication of interest according to some aspects.

FIG. 16 is a graph of an example of an indication of interest according to some aspects.

FIG. 17 is a flow chart of an example of a process for generating an updated indication of interest according to some aspects.

FIG. 18 is a graph of an example of interest data according to some aspects.

In the appended figures, similar components or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of examples of the technology. But various examples can be practiced without these specific details. The figures and description are not intended to be restrictive.

The ensuing description provides examples only, and is not intended to limit the scope, applicability, or configuration of the disclosure. Rather, the ensuing description of the examples provides those skilled in the art with an enabling description for implementing an example. Various changes may be made in the function and arrangement of elements without departing from the spirit and scope of the technology as set forth in the appended claims.

Specific details are given in the following description to provide a thorough understanding of the examples. But the examples may be practiced without these specific details. For example, circuits, systems, networks, processes, and other components can be shown as components in block diagram form to prevent obscuring the examples in unnecessary detail. In other examples, well-known circuits, processes, algorithms, structures, and techniques may be shown without unnecessary detail in order to avoid obscuring the examples.

Also, individual examples can be described as a process that is depicted as a flowchart, a flow diagram, a data flow diagram, a structure diagram, or a block diagram. Although a flowchart can describe the operations as a sequential process, many of the operations can be performed in parallel or concurrently. In addition, the order of the operations can be re-arranged. A process is terminated when its operations are completed, but can have additional operations not included in a figure. A process can correspond to a method, a function, a procedure, a subroutine, a subprogram, etc. When a process corresponds to a function, its termination can correspond to a return of the function to the calling function or the main function.

Systems depicted in some of the figures can be provided in various configurations. In some examples, the systems can be configured as a distributed system where one or more components of the system are distributed across one or more networks in a cloud computing system.

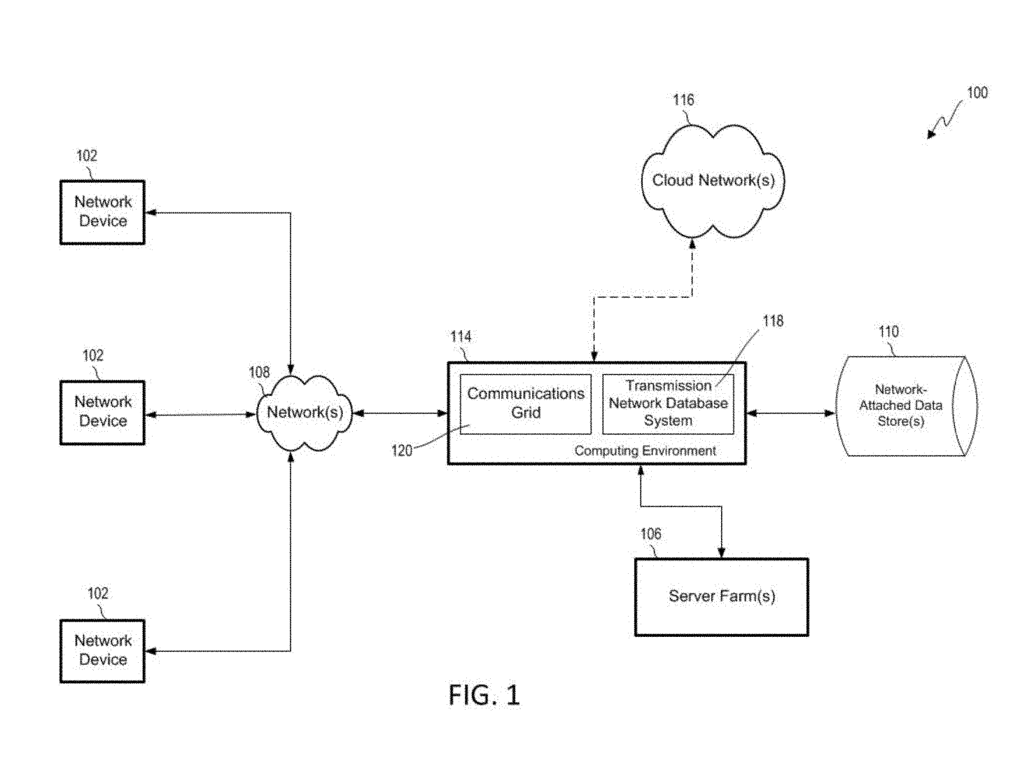

FIGS. 1-10 depict examples of systems and methods usable for automatically generating indications of interest according to some aspects. For example, FIG. 1 is a block diagram of an example of the hardware components of a computing system according to some aspects. Data transmission network 100 is a specialized computer system that may be used for processing large amounts of data where a large number of computer processing cycles are required.

Data transmission network 100 may also include computing environment 114. Computing environment 114 may be a specialized computer or other machine that processes the data received within the data transmission network 100. The computing environment 114 may include one or more other systems. For example, computing environment 114 may include a database system 118 or a communications grid 120.

Data transmission network 100 also includes one or more network devices 102. Network devices 102 may include client devices that can communicate with computing environment 114. For example, network devices 102 may send data to the computing environment 114 to be processed, may send communications to the computing environment 114 to control different aspects of the computing environment or the data it is processing, among other reasons. Network devices 102 may interact with the computing environment 114 through a number of ways, such as, for example, over one or more networks 108.

In some examples, network devices 102 may provide a large amount of data, either all at once or streaming over a period of time (e.g., using event stream processing (ESP)), to the computing environment 114 via networks 108. For example, the network devices 102 can transmit electronic messages for use in automatically generating indications of interest in an item, all at once or streaming over a period of time, to the computing environment 114 via networks 108.

The network devices 102 may include network computers, sensors, databases, or other devices that may transmit or otherwise provide data to computing environment 114. For example, network devices 102 may include local area network devices, such as routers, hubs, switches, or other computer networking devices. These devices may provide a variety of stored or generated data, such as network data or data specific to the network devices 102 themselves. Network devices 102 may also include sensors that monitor their environment or other devices to collect data regarding that environment or those devices, and such network devices 102 may provide data they collect over time. Network devices 102 may also include devices within the internet of things, such as devices within a home automation network. Some of these devices may be referred to as edge devices, and may involve edge-computing circuitry. Data may be transmitted by network devices 102 directly to computing environment 114 or to network-attached data stores, such as network-attached data stores 110 for storage so that the data may be retrieved later by the computing environment 114 or other portions of data transmission network 100. For example, the network devices 102 can transmit data usable for automatically generating indications of interest in an item to a network-attached data store 110 for storage. The computing environment 114 may later retrieve the data from the network-attached data store 110 and use the data to automatically generate indications of interest in the item.

Network-attached data stores 110 can store data to be processed by the computing environment 114 as well as any intermediate or final data generated by the computing system in non-volatile memory. But in certain examples, the configuration of the computing environment 114 allows its operations to be performed such that intermediate and final data results can be stored solely in volatile memory (e.g., RAM), without a requirement that intermediate or final data results be stored to non-volatile types of memory (e.g., disk). This can be useful in certain situations, such as when the computing environment 114 receives ad hoc queries from a user and when responses, which are generated by processing large amounts of data, need to be generated dynamically (e.g., on the fly). In this situation, the computing environment 114 may be configured to retain the processed information within memory so that responses can be generated for the user at different levels of detail as well as allow a user to interactively query against this information.

Network-attached data stores 110 may store a variety of different types of data organized in a variety of different ways and from a variety of different sources. For example, network-attached data stores may include storage other than primary storage located within computing environment 114 that is directly accessible by processors located therein. Network-attached data stores may include secondary, tertiary or auxiliary storage, such as large hard drives, servers, virtual memory, among other types. Storage devices may include portable or non-portable storage devices, optical storage devices, and various other mediums capable of storing, containing data. A machine-readable storage medium or computer-readable storage medium may include a non-transitory medium in which data can be stored and that does not include carrier waves or transitory electronic communications. Examples of a non-transitory medium may include, for example, a magnetic disk or tape, optical storage media such as compact disk or digital versatile disk, flash memory, memory or memory devices. A computer-program product may include code or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing or receiving information, data, arguments, parameters, or memory contents. Information, arguments, parameters, data, etc. may be passed, forwarded, or transmitted via any suitable means including memory sharing, message passing, token passing, network transmission, among others. Furthermore, the data stores may hold a variety of different types of data. For example, network-attached data stores 110 may hold unstructured (e.g., raw) data.

The unstructured data may be presented to the computing environment 114 in different forms such as a flat file or a conglomerate of data records, and may have data values and accompanying time stamps. The computing environment 114 may be used to analyze the unstructured data in a variety of ways to determine the best way to structure (e.g., hierarchically) that data, such that the structured data is tailored to a type of further analysis that a user wishes to perform on the data. For example, after being processed, the unstructured time-stamped data may be aggregated by time (e.g., into daily time period units) to generate time series data or structured hierarchically according to one or more dimensions (e.g., parameters, attributes, or variables). For example, data may be stored in a hierarchical data structure, such as a relational online analytical processing (ROLAP) or multidimensional online analytical processing (MOLAP) database, or may be stored in another tabular form, such as in a flat-hierarchy form.

Data transmission network 100 may also include one or more server farms 106. Computing environment 114 may route select communications or data to the sever farms 106 or one or more servers within the server farms 106. Server farms 106 can be configured to provide information in a predetermined manner. For example, server farms 106 may access data to transmit in response to a communication. Server farms 106 may be separately housed from each other device within data transmission network 100, such as computing environment 114, or may be part of a device or system.

Server farms 106 may host a variety of different types of data processing as part of data transmission network 100. Server farms 106 may receive a variety of different data from network devices, from computing environment 114, from cloud network 116, or from other sources. The data may have been obtained or collected from one or more websites, sensors, as inputs from a control database, or may have been received as inputs from an external system or device. Server farms 106 may assist in processing the data by turning raw data into processed data based on one or more rules implemented by the server farms. For example, sensor data may be analyzed to determine changes in an environment over time or in real-time.

Data transmission network 100 may also include one or more cloud networks 116. Cloud network 116 may include a cloud infrastructure system that provides cloud services. In certain examples, services provided by the cloud network 116 may include a host of services that are made available to users of the cloud infrastructure system on demand. Cloud network 116 is shown in FIG. 1 as being connected to computing environment 114 (and therefore having computing environment 114 as its client or user), but cloud network 116 may be connected to or utilized by any of the devices in FIG. 1. Services provided by the cloud network 116 can dynamically scale to meet the needs of its users. The cloud network 116 may include one or more computers, servers, or systems. In some examples, the computers, servers, or systems that make up the cloud network 116 are different from the user's own on-premises computers, servers, or systems. For example, the cloud network 116 may host an application, and a user may, via a communication network such as the Internet, order and use the application on demand. In some examples, the cloud network 116 may host an application for automatically generating indications of interest in an item.

While each device, server, and system in FIG. 1 is shown as a single device, multiple devices may instead be used. For example, a set of network devices can be used to transmit various communications from a single user, or remote server 140 may include a server stack. As another example, data may be processed as part of computing environment 114.

Each communication within data transmission network 100 (e.g., between client devices, between a device and connection management system 150, between server farms 106 and computing environment 114, or between a server and a device) may occur over one or more networks 108. Networks 108 may include one or more of a variety of different types of networks, including a wireless network, a wired network, or a combination of a wired and wireless network. Examples of suitable networks include the Internet, a personal area network, a local area network (LAN), a wide area network (WAN), or a wireless local area network (WLAN). A wireless network may include a wireless interface or combination of wireless interfaces. As an example, a network in the one or more networks 108 may include a short-range communication channel, such as a Bluetooth or a Bluetooth Low Energy channel. A wired network may include a wired interface. The wired or wireless networks may be implemented using routers, access points, bridges, gateways, or the like, to connect devices in the network 108. The networks 108 can be incorporated entirely within or can include an intranet, an extranet, or a combination thereof. In one example, communications between two or more systems or devices can be achieved by a secure communications protocol, such as secure sockets layer (SSL) or transport layer security (TLS). In addition, data or transactional details may be encrypted.

Some aspects may utilize the Internet of Things (IoT), where things (e.g., machines, devices, phones, sensors) can be connected to networks and the data from these things can be collected and processed within the things or external to the things. For example, the IoT can include sensors in many different devices, and high value analytics can be applied to identify hidden relationships and drive increased efficiencies. This can apply to both big data analytics and real-time (e.g., ESP) analytics.

As noted, computing environment 114 may include a communications grid 120 and a transmission network database system 118. Communications grid 120 may be a grid-based computing system for processing large amounts of data. The transmission network database system 118 may be for managing, storing, and retrieving large amounts of data that are distributed to and stored in the one or more network-attached data stores 110 or other data stores that reside at different locations within the transmission network database system 118. The computing nodes in the communications grid 120 and the transmission network database system 118 may share the same processor hardware, such as processors that are located within computing environment 114.

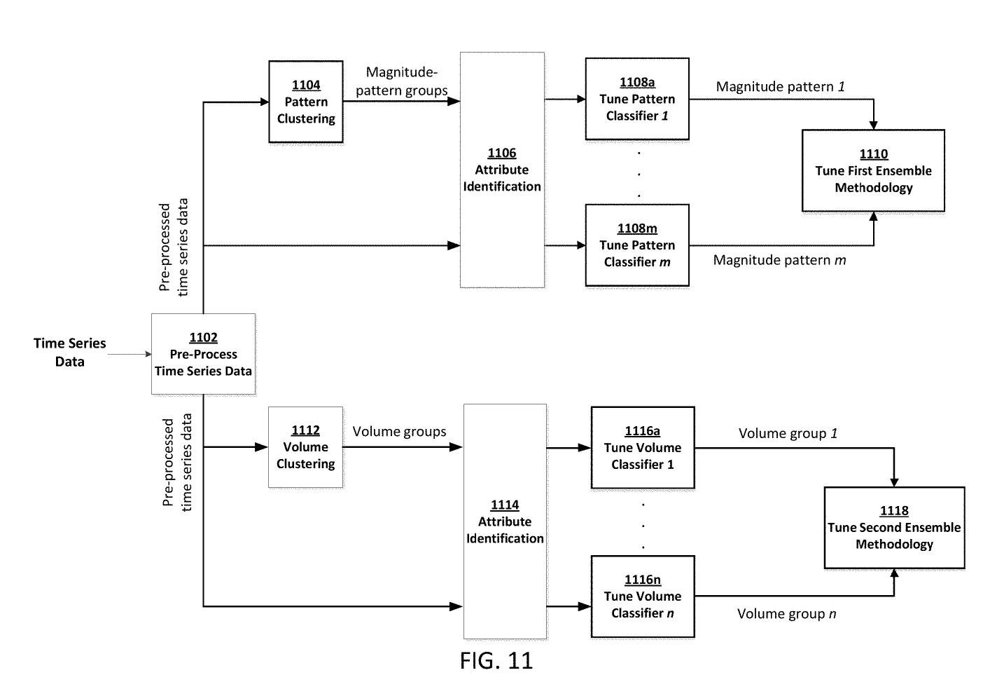

In some examples, the computing environment 114, a network device 102, or both can implement one or more processes for automatically generating indications of interest in an item. For example, the computing environment 114, a network device 102, or both can implement one or more versions of the processes discussed with respect to FIGS. 11, 13-15, and 17.

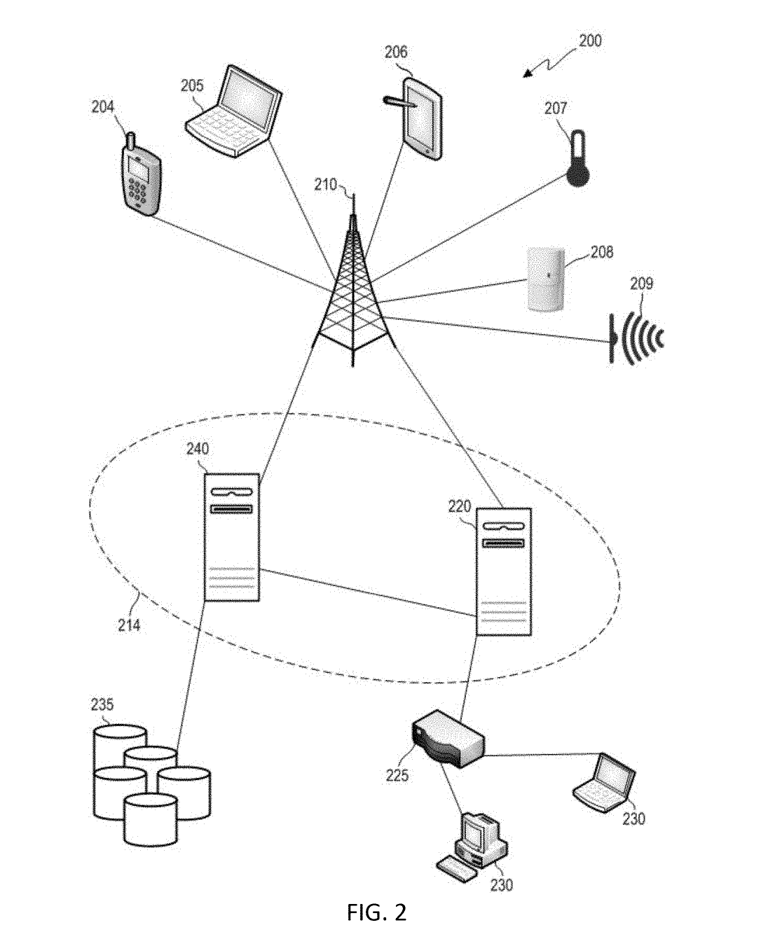

FIG. 2 is an example of devices that can communicate with each other over an exchange system and via a network according to some aspects. As noted, each communication within data transmission network 100 may occur over one or more networks. System 200 includes a network device 204 configured to communicate with a variety of types of client devices, for example client devices 230, over a variety of types of communication channels.

As shown in FIG. 2, network device 204 can transmit a communication over a network (e.g., a cellular network via a base station 210). In some examples, the communication can include times series data. The communication can be routed to another network device, such as network devices 205-209, via base station 210. The communication can also be routed to computing environment 214 via base station 210. In some examples, the network device 204 may collect data either from its surrounding environment or from other network devices (such as network devices 205-209) and transmit that data to computing environment 214.

Although network devices 204-209 are shown in FIG. 2 as a mobile phone, laptop computer, tablet computer, temperature sensor, motion sensor, and audio sensor respectively, the network devices may be or include sensors that are sensitive to detecting aspects of their environment. For example, the network devices may include sensors such as water sensors, power sensors, electrical current sensors, chemical sensors, optical sensors, pressure sensors, geographic or position sensors (e.g., GPS), velocity sensors, acceleration sensors, flow rate sensors, among others. Examples of characteristics that may be sensed include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, and electrical current, among others. The sensors may be mounted to various components used as part of a variety of different types of systems. The network devices may detect and record data related to the environment that it monitors, and transmit that data to computing environment 214.

The network devices 204-209 may also perform processing on data it collects before transmitting the data to the computing environment 214, or before deciding whether to transmit data to the computing environment 214. For example, network devices 204-209 may determine whether data collected meets certain rules, for example by comparing data or values calculated from the data and comparing that data to one or more thresholds. The network devices 204-209 may use this data or comparisons to determine if the data is to be transmitted to the computing environment 214 for further use or processing. In some examples, the network devices 204-209 can pre-process the data prior to transmitting the data to the computing environment 214. For example, the network devices 204-209 can reformat the data before transmitting the data to the computing environment 214 for further processing (e.g., analyzing the data to automatically generate indications of interest in an item).

Computing environment 214 may include machines 220, 240. Although computing environment 214 is shown in FIG. 2 as having two machines 220, 240, computing environment 214 may have only one machine or may have more than two machines. The machines 220, 240 that make up computing environment 214 may include specialized computers, servers, or other machines that are configured to individually or collectively process large amounts of data. The computing environment 214 may also include storage devices that include one or more databases of structured data, such as data organized in one or more hierarchies, or unstructured data. The databases may communicate with the processing devices within computing environment 214 to distribute data to them. Since network devices may transmit data to computing environment 214, that data may be received by the computing environment 214 and subsequently stored within those storage devices. Data used by computing environment 214 may also be stored in data stores 235, which may also be a part of or connected to computing environment 214.

Computing environment 214 can communicate with various devices via one or more routers 225 or other inter-network or intra-network connection components. For example, computing environment 214 may communicate with client devices 230 via one or more routers 225. Computing environment 214 may collect, analyze or store data from or pertaining to communications, client device operations, client rules, or user-associated actions stored at one or more data stores 235. Such data may influence communication routing to the devices within computing environment 214, how data is stored or processed within computing environment 214, among other actions.

Notably, various other devices can further be used to influence communication routing or processing between devices within computing environment 214 and with devices outside of computing environment 214. For example, as shown in FIG. 2, computing environment 214 may include a machine 240 that is a web server. Computing environment 214 can retrieve data of interest, such as client information (e.g., product information, client rules, etc.), technical product details, news, blog posts, e-mails, forum posts, electronic documents, social media posts (e.g., Twitter™ posts or Facebook™ posts), time series data, and so on.

In addition to computing environment 214 collecting data (e.g., as received from network devices, such as sensors, and client devices or other sources) to be processed as part of a big data analytics project, it may also receive data in real time as part of a streaming analytics environment. As noted, data may be collected using a variety of sources as communicated via different kinds of networks or locally. Such data may be received on a real-time streaming basis. For example, network devices 204-209 may receive data periodically and in real time from a web server or other source. Devices within computing environment 214 may also perform pre-analysis on data it receives to determine if the data received should be processed as part of an ongoing project. For example, as part of a project in which indications of interest in an item are automatically generated from data, the computing environment 214 can perform a pre-analysis of the data. The pre-analysis can include determining whether the data is in a correct format for automatically generating indications of interest in the item using the data and, if not, reformatting the data into the correct format.

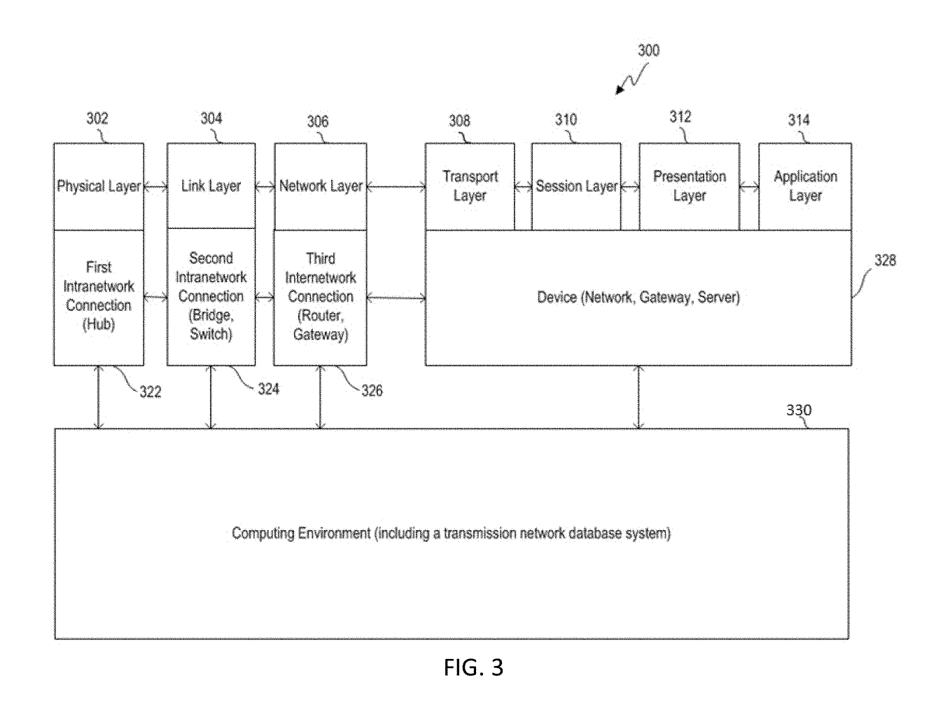

FIG. 3 is a block diagram of a model of an example of a communications protocol system according to some aspects. More specifically, FIG. 3 identifies operation of a computing environment in an Open Systems Interaction model that corresponds to various connection components. The model 300 shows, for example, how a computing environment, such as computing environment (or computing environment 214 in FIG. 2) may communicate with other devices in its network, and control how communications between the computing environment and other devices are executed and under what conditions.

The model 300 can include layers 302-314. The layers 302-314 are arranged in a stack. Each layer in the stack serves the layer one level higher than it (except for the application layer, which is the highest layer), and is served by the layer one level below it (except for the physical layer 302, which is the lowest layer). The physical layer 302 is the lowest layer because it receives and transmits raw bites of data, and is the farthest layer from the user in a communications system. On the other hand, the application layer is the highest layer because it interacts directly with a software application.

As noted, the model 300 includes a physical layer 302. Physical layer 302 represents physical communication, and can define parameters of that physical communication. For example, such physical communication may come in the form of electrical, optical, or electromagnetic communications. Physical layer 302 also defines protocols that may control communications within a data transmission network.

Link layer 304 defines links and mechanisms used to transmit (e.g., move) data across a network. The link layer manages node-to-node communications, such as within a grid-computing environment. Link layer 304 can detect and correct errors (e.g., transmission errors in the physical layer 302). Link layer 304 can also include a media access control (MAC) layer and logical link control (LLC) layer.

Network layer 306 can define the protocol for routing within a network. In other words, the network layer coordinates transferring data across nodes in a same network (e.g., such as a grid-computing environment). Network layer 306 can also define the processes used to structure local addressing within the network.

Transport layer 308 can manage the transmission of data and the quality of the transmission or receipt of that data. Transport layer 308 can provide a protocol for transferring data, such as, for example, a Transmission Control Protocol (TCP). Transport layer 308 can assemble and disassemble data frames for transmission. The transport layer can also detect transmission errors occurring in the layers below it.

Session layer 310 can establish, maintain, and manage communication connections between devices on a network. In other words, the session layer controls the dialogues or nature of communications between network devices on the network. The session layer may also establish checkpointing, adjournment, termination, and restart procedures.

Presentation layer 312 can provide translation for communications between the application and network layers. In other words, this layer may encrypt, decrypt or format data based on data types known to be accepted by an application or network layer.

Application layer 314 interacts directly with software applications and end users, and manages communications between them. Application layer 314 can identify destinations, local resource states or availability or communication content or formatting using the applications.

For example, a communication link can be established between two devices on a network. One device can transmit an analog or digital representation of an electronic message that includes a data set to the other device. The other device can receive the analog or digital representation at the physical layer 302. The other device can transmit the data associated with the electronic message through the remaining layers 304-314. The application layer 314 can receive data associated with the electronic message. The application layer 314 can identify one or more applications, such as an application for automatically generating indications of interest in an item, to which to transmit data associated with the electronic message. The application layer 314 can transmit the data to the identified application.

Intra-network connection components 322, 324 can operate in lower levels, such as physical layer 302 and link layer 304, respectively. For example, a hub can operate in the physical layer, a switch can operate in the physical layer, and a router can operate in the network layer. Inter-network connection components 326, 328 are shown to operate on higher levels, such as layers 306-314. For example, routers can operate in the network layer and network devices can operate in the transport, session, presentation, and application layers.

A computing environment 330 can interact with or operate on, in various examples, one, more, all or any of the various layers. For example, computing environment 330 can interact with a hub (e.g., via the link layer) to adjust which devices the hub communicates with. The physical layer 302 may be served by the link layer 304, so it may implement such data from the link layer 304. For example, the computing environment 330 may control which devices from which it can receive data. For example, if the computing environment 330 knows that a certain network device has turned off, broken, or otherwise become unavailable or unreliable, the computing environment 330 may instruct the hub to prevent any data from being transmitted to the computing environment 330 from that network device. Such a process may be beneficial to avoid receiving data that is inaccurate or that has been influenced by an uncontrolled environment. As another example, computing environment 330 can communicate with a bridge, switch, router or gateway and influence which device within the system (e.g., system 200) the component selects as a destination. In some examples, computing environment 330 can interact with various layers by exchanging communications with equipment operating on a particular layer by routing or modifying existing communications. In another example, such as in a grid-computing environment, a node may determine how data within the environment should be routed (e.g., which node should receive certain data) based on certain parameters or information provided by other layers within the model.

The computing environment 330 may be a part of a communications grid environment, the communications of which may be implemented as shown in the protocol of FIG. 3. For example, referring back to FIG. 2, one or more of machines 220 and 240 may be part of a communications grid-computing environment. A gridded computing environment may be employed in a distributed system with non-interactive workloads where data resides in memory on the machines, or compute nodes. In such an environment, analytic code, instead of a database management system, can control the processing performed by the nodes. Data is co-located by pre-distributing it to the grid nodes, and the analytic code on each node loads the local data into memory. Each node may be assigned a particular task, such as a portion of a processing project, or to organize or control other nodes within the grid. For example, each node may be assigned a portion of a processing task for automatically generating indications of interest in an item.

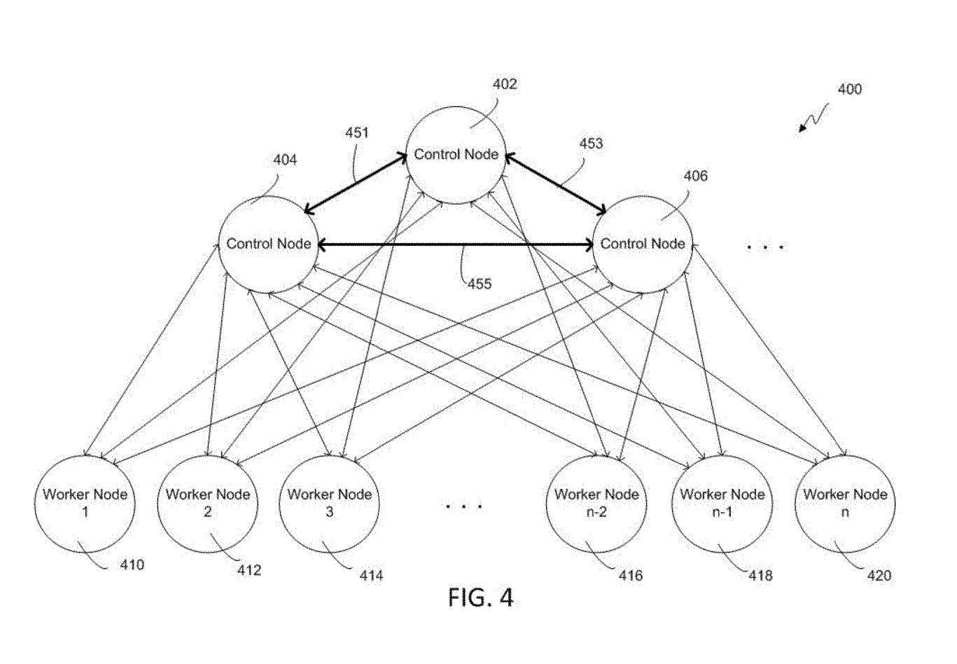

FIG. 4 is a hierarchical diagram of an example of a communications grid computing system 400 including a variety of control and worker nodes according to some aspects. Communications grid computing system 400 includes three control nodes and one or more worker nodes. Communications grid computing system 400 includes control nodes 402, 404, and 406. The control nodes are communicatively connected via communication paths 451, 453, and 455. The control nodes 402-406 may transmit information (e.g., related to the communications grid or notifications) to and receive information from each other. Although communications grid computing system 400 is shown in FIG. 4 as including three control nodes, the communications grid may include more or less than three control nodes.

Communications grid computing system 400 (which can be referred to as a “communications grid”) also includes one or more worker nodes. Shown in FIG. 4 are six worker nodes 410-420. Although FIG. 4 shows six worker nodes, a communications grid can include more or less than six worker nodes. The number of worker nodes included in a communications grid may be dependent upon how large the project or data set is being processed by the communications grid, the capacity of each worker node, the time designated for the communications grid to complete the project, among others. Each worker node within the communications grid computing system 400 may be connected (wired or wirelessly, and directly or indirectly) to control nodes 402-406. Each worker node may receive information from the control nodes (e.g., an instruction to perform work on a project) and may transmit information to the control nodes (e.g., a result from work performed on a project). Furthermore, worker nodes may communicate with each other directly or indirectly. For example, worker nodes may transmit data between each other related to a job being performed or an individual task within a job being performed by that worker node. In some examples, worker nodes may not be connected (communicatively or otherwise) to certain other worker nodes. For example, a worker node 410 may only be able to communicate with a particular control node 402. The worker node 410 may be unable to communicate with other worker nodes 412-420 in the communications grid, even if the other worker nodes 412-420 are controlled by the same control node 402.

A control node 402-406 may connect with an external device with which the control node 402-406 may communicate (e.g., a communications grid user, such as a server or computer, may connect to a controller of the grid). For example, a server or computer may connect to control nodes 402-406 and may transmit a project or job to the node, such as a project or job related to automatically generating indications of interest in an item. The project may include the data set. The data set may be of any size and can include a time series. Once the control node 402-406 receives such a project including a large data set, the control node may distribute the data set or projects related to the data set to be performed by worker nodes. Alternatively, for a project including a large data set, the data set may be receive or stored by a machine other than a control node 402-406 (e.g., a Hadoop data node).

Control nodes 402-406 can maintain knowledge of the status of the nodes in the grid (e.g., grid status information), accept work requests from clients, subdivide the work across worker nodes, and coordinate the worker nodes, among other responsibilities. Worker nodes 412-420 may accept work requests from a control node 402-406 and provide the control node with results of the work performed by the worker node. A grid may be started from a single node (e.g., a machine, computer, server, etc.). This first node may be assigned or may start as the primary control node 402 that will control any additional nodes that enter the grid.

When a project is submitted for execution (e.g., by a client or a controller of the grid) it may be assigned to a set of nodes. After the nodes are assigned to a project, a data structure (e.g., a communicator) may be created. The communicator may be used by the project for information to be shared between the project code running on each node. A communication handle may be created on each node. A handle, for example, is a reference to the communicator that is valid within a single process on a single node, and the handle may be used when requesting communications between nodes.

A control node, such as control node 402, may be designated as the primary control node. A server, computer or other external device may connect to the primary control node. Once the control node 402 receives a project, the primary control node may distribute portions of the project to its worker nodes for execution. For example, a project for predicting future interest in an item can be initiated on communications grid computing system 400. A primary control node can control the work to be performed for the project in order to complete the project as requested or instructed. The primary control node may distribute work to the worker nodes 412-420 based on various factors, such as which subsets or portions of projects may be completed most efficiently and in the correct amount of time. For example, a worker node 412 may automatically generate indications of interest in an item using at least a portion of data that is already local (e.g., stored on) the worker node. The primary control node also coordinates and processes the results of the work performed by each worker node 412-420 after each worker node 412-420 executes and completes its job. For example, the primary control node may receive a result from one or more worker nodes 412-420, and the primary control node may organize (e.g., collect and assemble) the results received and compile them to produce a complete result for the project received from the end user.

Any remaining control nodes, such as control nodes 404, 406, may be assigned as backup control nodes for the project. In an example, backup control nodes may not control any portion of the project. Instead, backup control nodes may serve as a backup for the primary control node and take over as primary control node if the primary control node were to fail. If a communications grid were to include only a single control node 402, and the control node 402 were to fail (e.g., the control node is shut off or breaks) then the communications grid as a whole may fail and any project or job being run on the communications grid may fail and may not complete. While the project may be run again, such a failure may cause a delay (severe delay in some cases, such as overnight delay) in completion of the project. Therefore, a grid with multiple control nodes 402-406, including a backup control node, may be beneficial.

In some examples, the primary control node may open a pair of listening sockets to add another node or machine to the grid. A socket may be used to accept work requests from clients, and the second socket may be used to accept connections from other grid nodes. The primary control node may be provided with a list of other nodes (e.g., other machines, computers, servers, etc.) that can participate in the grid, and the role that each node can fill in the grid. Upon startup of the primary control node (e.g., the first node on the grid), the primary control node may use a network protocol to start the server process on every other node in the grid. Command line parameters, for example, may inform each node of one or more pieces of information, such as: the role that the node will have in the grid, the host name of the primary control node, the port number on which the primary control node is accepting connections from peer nodes, among others. The information may also be provided in a configuration file, transmitted over a secure shell tunnel, recovered from a configuration server, among others. While the other machines in the grid may not initially know about the configuration of the grid, that information may also be sent to each other node by the primary control node. Updates of the grid information may also be subsequently sent to those nodes.

For any control node other than the primary control node added to the grid, the control node may open three sockets. The first socket may accept work requests from clients, the second socket may accept connections from other grid members, and the third socket may connect (e.g., permanently) to the primary control node. When a control node (e.g., primary control node) receives a connection from another control node, it first checks to see if the peer node is in the list of configured nodes in the grid. If it is not on the list, the control node may clear the connection. If it is on the list, it may then attempt to authenticate the connection. If authentication is successful, the authenticating node may transmit information to its peer, such as the port number on which a node is listening for connections, the host name of the node, information about how to authenticate the node, among other information. When a node, such as the new control node, receives information about another active node, it can check to see if it already has a connection to that other node. If it does not have a connection to that node, it may then establish a connection to that control node.

Any worker node added to the grid may establish a connection to the primary control node and any other control nodes on the grid. After establishing the connection, it may authenticate itself to the grid (e.g., any control nodes, including both primary and backup, or a server or user controlling the grid). After successful authentication, the worker node may accept configuration information from the control node.

When a node joins a communications grid (e.g., when the node is powered on or connected to an existing node on the grid or both), the node is assigned (e.g., by an operating system of the grid) a universally unique identifier (UUID). This unique identifier may help other nodes and external entities (devices, users, etc.) to identify the node and distinguish it from other nodes. When a node is connected to the grid, the node may share its unique identifier with the other nodes in the grid. Since each node may share its unique identifier, each node may know the unique identifier of every other node on the grid. Unique identifiers may also designate a hierarchy of each of the nodes (e.g., backup control nodes) within the grid. For example, the unique identifiers of each of the backup control nodes may be stored in a list of backup control nodes to indicate an order in which the backup control nodes will take over for a failed primary control node to become a new primary control node. But, a hierarchy of nodes may also be determined using methods other than using the unique identifiers of the nodes. For example, the hierarchy may be predetermined, or may be assigned based on other predetermined factors.

The grid may add new machines at any time (e.g., initiated from any control node). Upon adding a new node to the grid, the control node may first add the new node to its table of grid nodes. The control node may also then notify every other control node about the new node. The nodes receiving the notification may acknowledge that they have updated their configuration information.

Primary control node 402 may, for example, transmit one or more communications to backup control nodes 404, 406 (and, for example, to other control or worker nodes 412-420 within the communications grid). Such communications may be sent periodically, at fixed time intervals, between known fixed stages of the project's execution, among other protocols. The communications transmitted by primary control node 402 may be of varied types and may include a variety of types of information. For example, primary control node 402 may transmit snapshots (e.g., status information) of the communications grid so that backup control node 404 always has a recent snapshot of the communications grid. The snapshot or grid status may include, for example, the structure of the grid (including, for example, the worker nodes 410-420 in the communications grid, unique identifiers of the worker nodes 410-420, or their relationships with the primary control node 402) and the status of a project (including, for example, the status of each worker node's portion of the project). The snapshot may also include analysis or results received from worker nodes 410-420 in the communications grid. The backup control nodes 404, 406 may receive and store the backup data received from the primary control node 402. The backup control nodes 404, 406 may transmit a request for such a snapshot (or other information) from the primary control node 402, or the primary control node 402 may send such information periodically to the backup control nodes 404, 406.

As noted, the backup data may allow a backup control node 404, 406 to take over as primary control node if the primary control node 402 fails without requiring the communications grid to start the project over from scratch. If the primary control node 402 fails, the backup control node 404, 406 that will take over as primary control node may retrieve the most recent version of the snapshot received from the primary control node 402 and use the snapshot to continue the project from the stage of the project indicated by the backup data. This may prevent failure of the project as a whole.

A backup control node 404, 406 may use various methods to determine that the primary control node 402 has failed. In one example of such a method, the primary control node 402 may transmit (e.g., periodically) a communication to the backup control node 404, 406 that indicates that the primary control node 402 is working and has not failed, such as a heartbeat communication. The backup control node 404, 406 may determine that the primary control node 402 has failed if the backup control node has not received a heartbeat communication for a certain predetermined period of time. Alternatively, a backup control node 404, 406 may also receive a communication from the primary control node 402 itself (before it failed) or from a worker node 410-420 that the primary control node 402 has failed, for example because the primary control node 402 has failed to communicate with the worker node 410-420.

Different methods may be performed to determine which backup control node of a set of backup control nodes (e.g., backup control nodes 404, 406) can take over for failed primary control node 402 and become the new primary control node. For example, the new primary control node may be chosen based on a ranking or “hierarchy” of backup control nodes based on their unique identifiers. In an alternative example, a backup control node may be assigned to be the new primary control node by another device in the communications grid or from an external device (e.g., a system infrastructure or an end user, such as a server or computer, controlling the communications grid). In another alternative example, the backup control node that takes over as the new primary control node may be designated based on bandwidth or other statistics about the communications grid.

A worker node within the communications grid may also fail. If a worker node fails, work being performed by the failed worker node may be redistributed amongst the operational worker nodes. In an alternative example, the primary control node may transmit a communication to each of the operable worker nodes still on the communications grid that each of the worker nodes should purposefully fail also. After each of the worker nodes fail, they may each retrieve their most recent saved checkpoint of their status and re-start the project from that checkpoint to minimize lost progress on the project being executed. In some examples, a communications grid computing system 400 can be used to automatically generate indications of interest in an item.

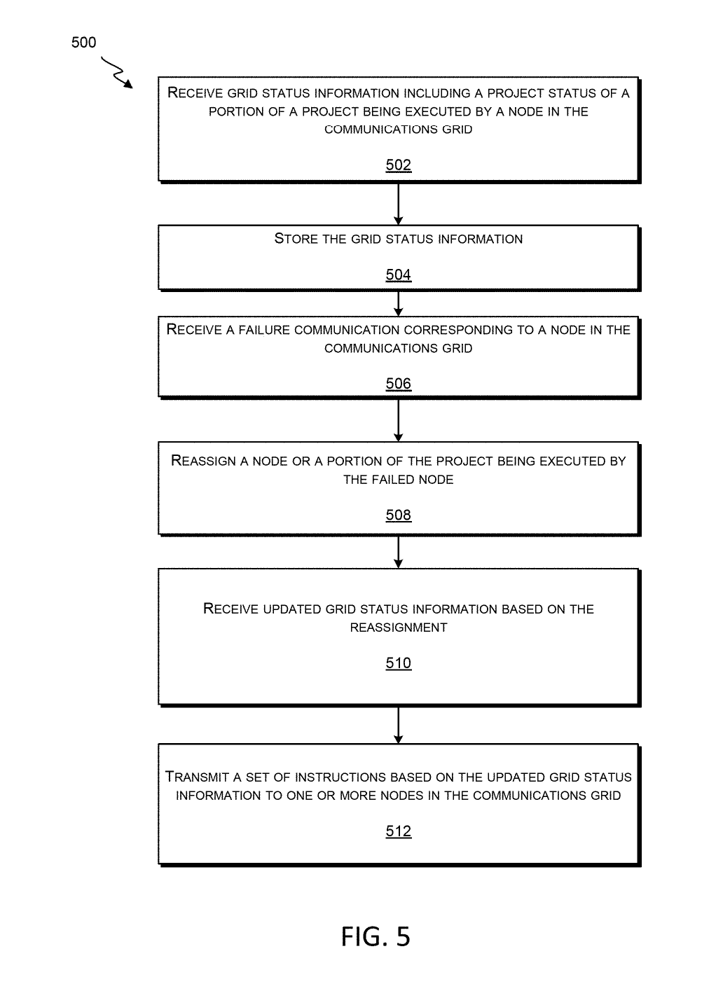

FIG. 5 is a flow chart of an example of a process for adjusting a communications grid or a work project in a communications grid after a failure of a node according to some aspects. The process may include, for example, receiving grid status information including a project status of a portion of a project being executed by a node in the communications grid, as described in operation 502. For example, a control node (e.g., a backup control node connected to a primary control node and a worker node on a communications grid) may receive grid status information, where the grid status information includes a project status of the primary control node or a project status of the worker node. The project status of the primary control node and the project status of the worker node may include a status of one or more portions of a project being executed by the primary and worker nodes in the communications grid. The process may also include storing the grid status information, as described in operation 504. For example, a control node (e.g., a backup control node) may store the received grid status information locally within the control node. Alternatively, the grid status information may be sent to another device for storage where the control node may have access to the information.

The process may also include receiving a failure communication corresponding to a node in the communications grid in operation 506. For example, a node may receive a failure communication including an indication that the primary control node has failed, prompting a backup control node to take over for the primary control node. In an alternative embodiment, a node may receive a failure that a worker node has failed, prompting a control node to reassign the work being performed by the worker node. The process may also include reassigning a node or a portion of the project being executed by the failed node, as described in operation 508. For example, a control node may designate the backup control node as a new primary control node based on the failure communication upon receiving the failure communication. If the failed node is a worker node, a control node may identify a project status of the failed worker node using the snapshot of the communications grid, where the project status of the failed worker node includes a status of a portion of the project being executed by the failed worker node at the failure time.

The process may also include receiving updated grid status information based on the reassignment, as described in operation 510, and transmitting a set of instructions based on the updated grid status information to one or more nodes in the communications grid, as described in operation 512. The updated grid status information may include an updated project status of the primary control node or an updated project status of the worker node. The updated information may be transmitted to the other nodes in the grid to update their stale stored information.

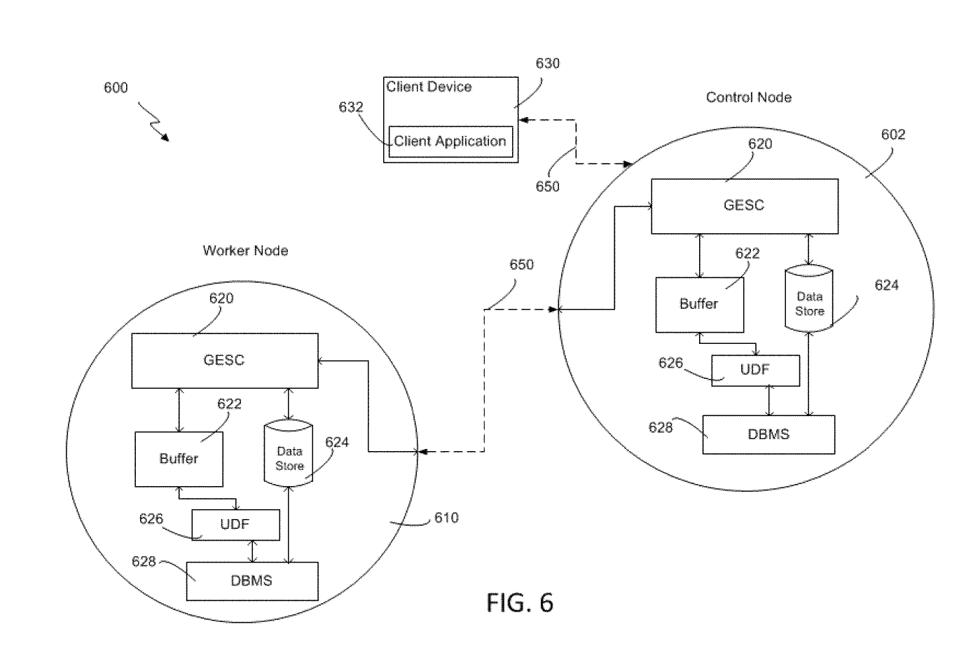

FIG. 6 is a block diagram of a portion of a communications grid computing system 600 including a control node and a worker node according to some aspects. Communications grid 600 computing system includes one control node (control node 602) and one worker node (worker node 610) for purposes of illustration, but may include more worker and/or control nodes. The control node 602 is communicatively connected to worker node 610 via communication path 650. Therefore, control node 602 may transmit information (e.g., related to the communications grid or notifications), to and receive information from worker node 610 via communication path 650.

Similar to in FIG. 4, communications grid computing system (or just “communications grid”) 600 includes data processing nodes (control node 602 and worker node 610). Nodes 602 and 610 comprise multi-core data processors. Each node 602 and 610 includes a grid-enabled software component (GESC) 620 that executes on the data processor associated with that node and interfaces with buffer memory 622 also associated with that node. Each node 602 and 610 includes a database management software (DBMS) 628 that executes on a database server (not shown) at control node 602 and on a database server (not shown) at worker node 610.

Each node also includes a data store 624. Data stores 624, similar to network-attached data stores 110 in FIG. 1 and data stores 235 in FIG. 2, are used to store data to be processed by the nodes in the computing environment. Data stores 624 may also store any intermediate or final data generated by the computing system after being processed, for example in non-volatile memory. However in certain examples, the configuration of the grid computing environment allows its operations to be performed such that intermediate and final data results can be stored solely in volatile memory (e.g., RAM), without a requirement that intermediate or final data results be stored to non-volatile types of memory. Storing such data in volatile memory may be useful in certain situations, such as when the grid receives queries (e.g., ad hoc) from a client and when responses, which are generated by processing large amounts of data, need to be generated quickly or on-the-fly. In such a situation, the grid may be configured to retain the data within memory so that responses can be generated at different levels of detail and so that a client may interactively query against this information.

Each node also includes a user-defined function (UDF) 626. The UDF provides a mechanism for the DMBS 628 to transfer data to or receive data from the database stored in the data stores 624 that are managed by the DBMS. For example, UDF 626 can be invoked by the DBMS to provide data to the GESC for processing. The UDF 626 may establish a socket connection (not shown) with the GESC to transfer the data. Alternatively, the UDF 626 can transfer data to the GESC by writing data to shared memory accessible by both the UDF and the GESC.

The GESC 620 at the nodes 602 and 610 may be connected via a network, such as network 108 shown in FIG. 1. Therefore, nodes 602 and 610 can communicate with each other via the network using a predetermined communication protocol such as, for example, the Message Passing Interface (MPI). Each GESC 620 can engage in point-to-point communication with the GESC at another node or in collective communication with multiple GESCs via the network. The GESC 620 at each node may contain identical (or nearly identical) software instructions. Each node may be capable of operating as either a control node or a worker node. The GESC at the control node 602 can communicate, over a communication path 652, with a client device 630. More specifically, control node 602 may communicate with client application 632 hosted by the client device 630 to receive queries and to respond to those queries after processing large amounts of data.

DMBS 628 may control the creation, maintenance, and use of database or data structure (not shown) within nodes 602 or 610. The database may organize data stored in data stores 624. The DMBS 628 at control node 602 may accept requests for data and transfer the appropriate data for the request. With such a process, collections of data may be distributed across multiple physical locations. In this example, each node 602 and 610 stores a portion of the total data managed by the management system in its associated data store 624.

Furthermore, the DBMS may be responsible for protecting against data loss using replication techniques. Replication includes providing a backup copy of data stored on one node on one or more other nodes. Therefore, if one node fails, the data from the failed node can be recovered from a replicated copy residing at another node. However, as described herein with respect to FIG. 4, data or status information for each node in the communications grid may also be shared with each node on the grid.

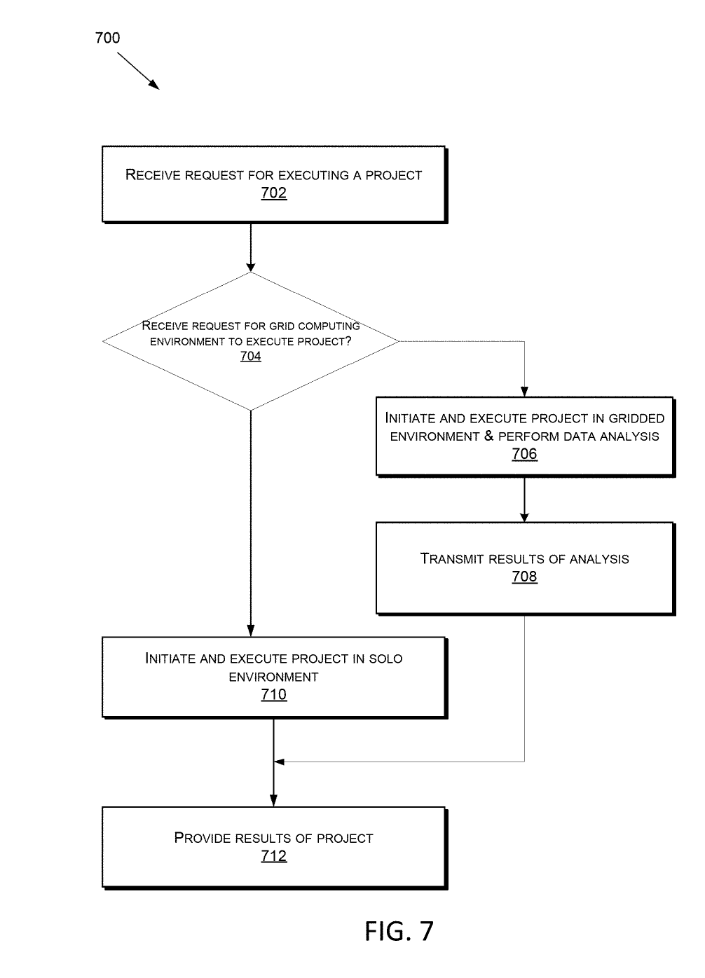

FIG. 7 is a flow chart of an example of a process for executing a data analysis or a processing project according to some aspects. As described with respect to FIG. 6, the GESC at the control node may transmit data with a client device (e.g., client device 630) to receive queries for executing a project and to respond to those queries after large amounts of data have been processed. The query may be transmitted to the control node, where the query may include a request for executing a project, as described in operation 702. The query can contain instructions on the type of data analysis to be performed in the project and whether the project should be executed using the grid-based computing environment, as shown in operation 704.

To initiate the project, the control node may determine if the query requests use of the grid-based computing environment to execute the project. If the determination is no, then the control node initiates execution of the project in a solo environment (e.g., at the control node), as described in operation 710. If the determination is yes, the control node may initiate execution of the project in the grid-based computing environment, as described in operation 706. In such a situation, the request may include a requested configuration of the grid. For example, the request may include a number of control nodes and a number of worker nodes to be used in the grid when executing the project. After the project has been completed, the control node may transmit results of the analysis yielded by the grid, as described in operation 708. Whether the project is executed in a solo or grid-based environment, the control node provides the results of the project.

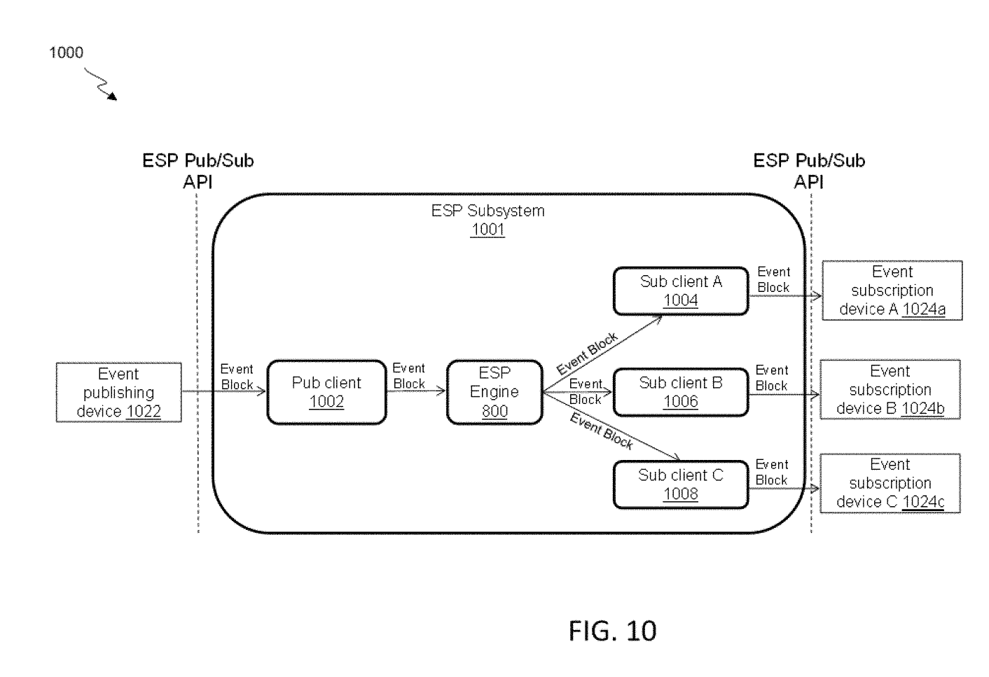

As noted with respect to FIG. 2, the computing environments described herein may collect data (e.g., as received from network devices, such as sensors, such as network devices 204-209 in FIG. 2, and client devices or other sources) to be processed as part of a data analytics project, and data may be received in real time as part of a streaming analytics environment (e.g., ESP). Data may be collected using a variety of sources as communicated via different kinds of networks or locally, such as on a real-time streaming basis. For example, network devices may receive data periodically from network device sensors as the sensors continuously sense, monitor and track changes in their environments. More specifically, an increasing number of distributed applications develop or produce continuously flowing data from distributed sources by applying queries to the data before distributing the data to geographically distributed recipients. An event stream processing engine (ESPE) may continuously apply the queries to the data as it is received and determines which entities should receive the data. Client or other devices may also subscribe to the ESPE or other devices processing ESP data so that they can receive data after processing, based on for example the entities determined by the processing engine. For example, client devices 230 in FIG. 2 may subscribe to the ESPE in computing environment 214. In another example, event subscription devices 1024a-c, described further with respect to FIG. 10, may also subscribe to the ESPE. The ESPE may determine or define how input data or event streams from network devices or other publishers (e.g., network devices 204-209 in FIG. 2) are transformed into meaningful output data to be consumed by subscribers, such as for example client devices 230 in FIG. 2.

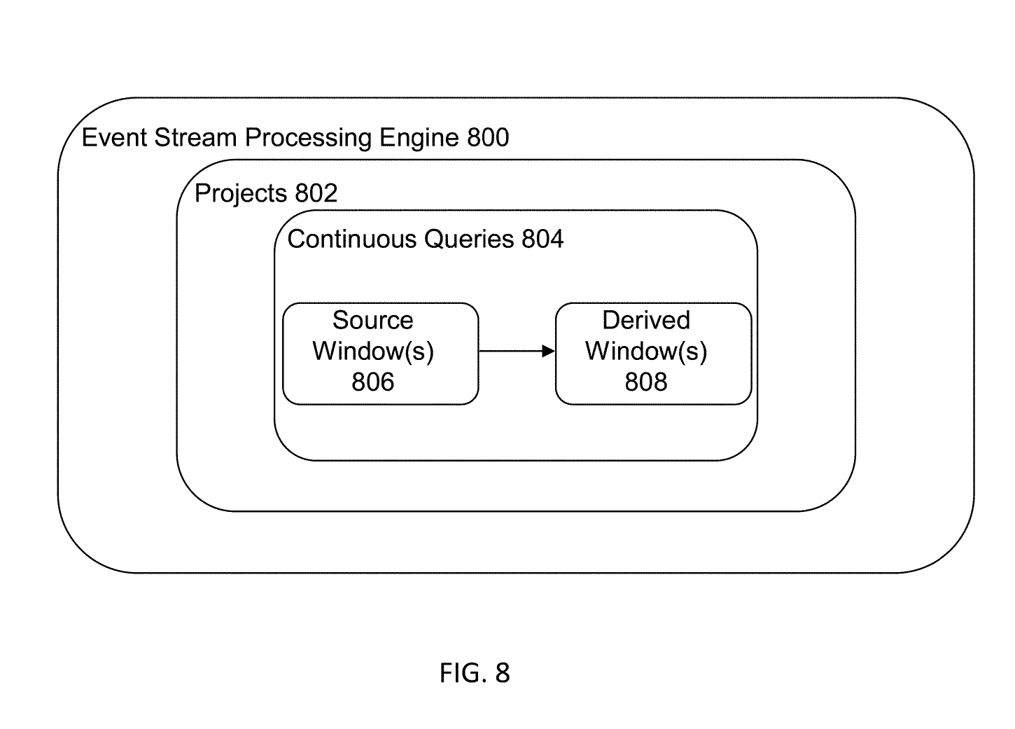

FIG. 8 is a block diagram including components of an Event Stream Processing Engine (ESPE) according to some aspects. ESPE 800 may include one or more projects 802. A project may be described as a second-level container in an engine model managed by ESPE 800 where a thread pool size for the project may be defined by a user. Each project of the one or more projects 802 may include one or more continuous queries 804 that contain data flows, which are data transformations of incoming event streams. The one or more continuous queries 804 may include one or more source windows 806 and one or more derived windows 808.

The ESPE may receive streaming data over a period of time related to certain events, such as events or other data sensed by one or more network devices. The ESPE may perform operations associated with processing data created by the one or more devices. For example, the ESPE may receive data from the one or more network devices 204-209 shown in FIG. 2. As noted, the network devices may include sensors that sense different aspects of their environments, and may collect data over time based on those sensed observations. For example, the ESPE may be implemented within one or more of machines 220 and 240 shown in FIG. 2. The ESPE may be implemented within such a machine by an ESP application. An ESP application may embed an ESPE with its own dedicated thread pool or pools into its application space where the main application thread can do application-specific work and the ESPE processes event streams at least by creating an instance of a model into processing objects.

The engine container is the top-level container in a model that manages the resources of the one or more projects 802. In an illustrative example, there may be only one ESPE 800 for each instance of the ESP application, and ESPE 800 may have a unique engine name. Additionally, the one or more projects 802 may each have unique project names, and each query may have a unique continuous query name and begin with a uniquely named source window of the one or more source windows 806. ESPE 800 may or may not be persistent.

Continuous query modeling involves defining directed graphs of windows for event stream manipulation and transformation. A window in the context of event stream manipulation and transformation is a processing node in an event stream processing model. A window in a continuous query can perform aggregations, computations, pattern-matching, and other operations on data flowing through the window. A continuous query may be described as a directed graph of source, relational, pattern matching, and procedural windows. The one or more source windows 806 and the one or more derived windows 808 represent continuously executing queries that generate updates to a query result set as new event blocks stream through ESPE 800. A directed graph, for example, is a set of nodes connected by edges, where the edges have a direction associated with them.

An event object may be described as a packet of data accessible as a collection of fields, with at least one of the fields defined as a key or unique identifier (ID). The event object may be created using a variety of formats including binary, alphanumeric, XML, etc. Each event object may include one or more fields designated as a primary identifier (ID) for the event so ESPE 800 can support operation codes (opcodes) for events including insert, update, upsert, and delete. Upsert opcodes update the event if the key field already exists; otherwise, the event is inserted. For illustration, an event object may be a packed binary representation of a set of field values and include both metadata and field data associated with an event. The metadata may include an opcode indicating if the event represents an insert, update, delete, or upsert, a set of flags indicating if the event is a normal, partial-update, or a retention generated event from retention policy management, and a set of microsecond timestamps that can be used for latency measurements.

An event block object may be described as a grouping or package of event objects. An event stream may be described as a flow of event block objects. A continuous query of the one or more continuous queries 804 transforms a source event stream made up of streaming event block objects published into ESPE 800 into one or more output event streams using the one or more source windows 806 and the one or more derived windows 808. A continuous query can also be thought of as data flow modeling.

The one or more source windows 806 are at the top of the directed graph and have no windows feeding into them. Event streams are published into the one or more source windows 806, and from there, the event streams may be directed to the next set of connected windows as defined by the directed graph. The one or more derived windows 808 are all instantiated windows that are not source windows and that have other windows streaming events into them. The one or more derived windows 808 may perform computations or transformations on the incoming event streams. The one or more derived windows 808 transform event streams based on the window type (that is operators such as join, filter, compute, aggregate, copy, pattern match, procedural, union, etc.) and window settings. As event streams are published into ESPE 800, they are continuously queried, and the resulting sets of derived windows in these queries are continuously updated.

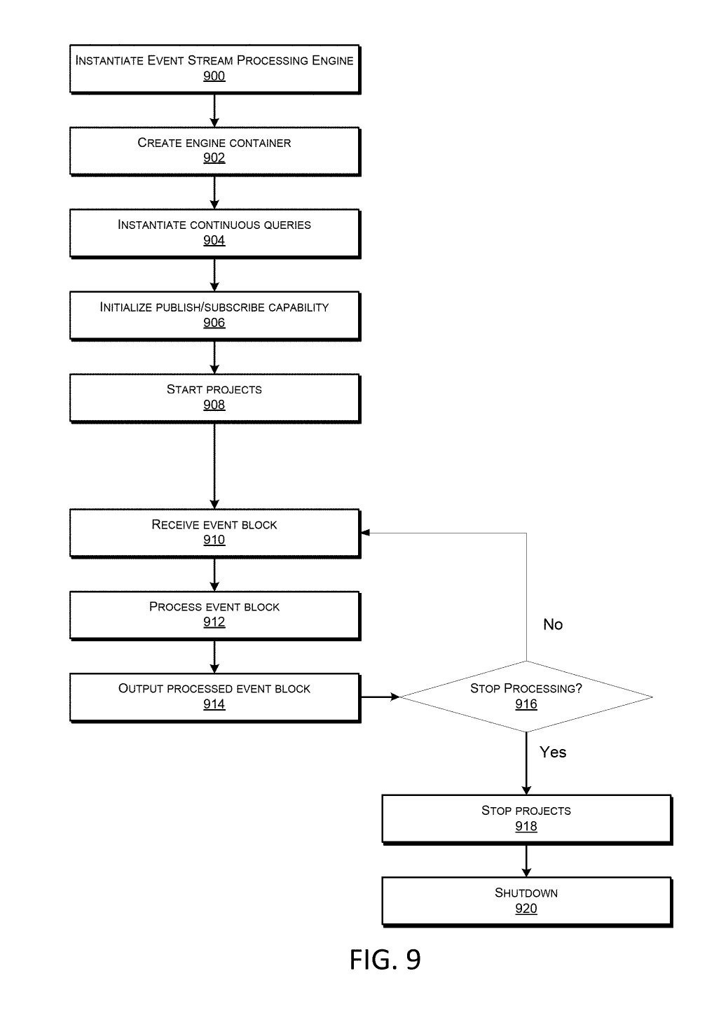

FIG. 9 is a flow chart of an example of a process including operations performed by an event stream processing engine according to some aspects. As noted, the ESPE 800 (or an associated ESP application) defines how input event streams are transformed into meaningful output event streams. More specifically, the ESP application may define how input event streams from publishers (e.g., network devices providing sensed data) are transformed into meaningful output event streams consumed by subscribers (e.g., a data analytics project being executed by a machine or set of machines).

Within the application, a user may interact with one or more user interface windows presented to the user in a display under control of the ESPE independently or through a browser application in an order selectable by the user. For example, a user may execute an ESP application, which causes presentation of a first user interface window, which may include a plurality of menus and selectors such as drop down menus, buttons, text boxes, hyperlinks, etc. associated with the ESP application as understood by a person of skill in the art. Various operations may be performed in parallel, for example, using a plurality of threads.

At operation 900, an ESP application may define and start an ESPE, thereby instantiating an ESPE at a device, such as machine 220 and/or 240. In an operation 902, the engine container is created. For illustration, ESPE 800 may be instantiated using a function call that specifies the engine container as a manager for the model.

In an operation 904, the one or more continuous queries 804 are instantiated by ESPE 800 as a model. The one or more continuous queries 804 may be instantiated with a dedicated thread pool or pools that generate updates as new events stream through ESPE 800. For illustration, the one or more continuous queries 804 may be created to model business processing logic within ESPE 800, to predict events within ESPE 800, to model a physical system within ESPE 800, to predict the physical system state within ESPE 800, etc. For example, as noted, ESPE 800 may be used to support sensor data monitoring and management (e.g., sensing may include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, or electrical current, etc.).

ESPE 800 may analyze and process events in motion or “event streams.” Instead of storing data and running queries against the stored data, ESPE 800 may store queries and stream data through them to allow continuous analysis of data as it is received. The one or more source windows 806 and the one or more derived windows 808 may be created based on the relational, pattern matching, and procedural algorithms that transform the input event streams into the output event streams to model, simulate, score, test, predict, etc. based on the continuous query model defined and application to the streamed data.

In an operation 906, a publish/subscribe (pub/sub) capability is initialized for ESPE 800. In an illustrative embodiment, a pub/sub capability is initialized for each project of the one or more projects 802. To initialize and enable pub/sub capability for ESPE 800, a port number may be provided. Pub/sub clients can use a host name of an ESP device running the ESPE and the port number to establish pub/sub connections to ESPE 800.

FIG. 10 is a block diagram of an ESP system 1000 interfacing between publishing device 1022 and event subscribing devices 1024a-c according to some aspects. ESP system 1000 may include ESP device or subsystem 1001, publishing device 1022, an event subscribing device A 1024a, an event subscribing device B 1024b, and an event subscribing device C 1024c. Input event streams are output to ESP device 1001 by publishing device 1022. In alternative embodiments, the input event streams may be created by a plurality of publishing devices. The plurality of publishing devices further may publish event streams to other ESP devices. The one or more continuous queries instantiated by ESPE 800 may analyze and process the input event streams to form output event streams output to event subscribing device A 1024a, event subscribing device B 1024b, and event subscribing device C 1024c. ESP system 1000 may include a greater or a fewer number of event subscribing devices of event subscribing devices.

Publish-subscribe is a message-oriented interaction paradigm based on indirect addressing. Processed data recipients specify their interest in receiving information from ESPE 800 by subscribing to specific classes of events, while information sources publish events to ESPE 800 without directly addressing the receiving parties. ESPE 800 coordinates the interactions and processes the data. In some cases, the data source receives confirmation that the published information has been received by a data recipient.

A publish/subscribe API may be described as a library that enables an event publisher, such as publishing device 1022, to publish event streams into ESPE 800 or an event subscriber, such as event subscribing device A 1024a, event subscribing device B 1024b, and event subscribing device C 1024c, to subscribe to event streams from ESPE 800. For illustration, one or more publish/subscribe APIs may be defined. Using the publish/subscribe API, an event publishing application may publish event streams into a running event stream processor project source window of ESPE 800, and the event subscription application may subscribe to an event stream processor project source window of ESPE 800.

The publish/subscribe API provides cross-platform connectivity and endianness compatibility between ESP application and other networked applications, such as event publishing applications instantiated at publishing device 1022, and event subscription applications instantiated at one or more of event subscribing device A 1024a, event subscribing device B 1024b, and event subscribing device C 1024c.

Referring back to FIG. 9, operation 906 initializes the publish/subscribe capability of ESPE 800. In an operation 908, the one or more projects 802 are started. The one or more started projects may run in the background on an ESP device. In an operation 910, an event block object is received from one or more computing device of the publishing device 1022.

ESP subsystem 800 may include a publishing client 1002, ESPE 800, a subscribing client A 1004, a subscribing client B 1006, and a subscribing client C 1008. Publishing client 1002 may be started by an event publishing application executing at publishing device 1022 using the publish/subscribe API. Subscribing client A 1004 may be started by an event subscription application A, executing at event subscribing device A 1024a using the publish/subscribe API. Subscribing client B 1006 may be started by an event subscription application B executing at event subscribing device B 1024b using the publish/subscribe API. Subscribing client C 1008 may be started by an event subscription application C executing at event subscribing device C 1024c using the publish/subscribe API.

An event block object containing one or more event objects is injected into a source window of the one or more source windows 806 from an instance of an event publishing application on publishing device 1022. The event block object may generated, for example, by the event publishing application and may be received by publishing client 1002. A unique ID may be maintained as the event block object is passed between the one or more source windows 806 and/or the one or more derived windows 808 of ESPE 800, and to subscribing client A 1004, subscribing client B 806, and subscribing client C 808 and to event subscription device A 1024a, event subscription device B 1024b, and event subscription device C 1024c. Publishing client 1002 may further generate and include a unique embedded transaction ID in the event block object as the event block object is processed by a continuous query, as well as the unique ID that publishing device 1022 assigned to the event block object.

In an operation 912, the event block object is processed through the one or more continuous queries 804. In an operation 914, the processed event block object is output to one or more computing devices of the event subscribing devices 1024a-c. For example, subscribing client A 804, subscribing client B 806, and subscribing client C 808 may send the received event block object to event subscription device A 1024a, event subscription device B 1024b, and event subscription device C 1024c, respectively.

ESPE 800 maintains the event block containership aspect of the received event blocks from when the event block is published into a source window and works its way through the directed graph defined by the one or more continuous queries 804 with the various event translations before being output to subscribers. Subscribers can correlate a group of subscribed events back to a group of published events by comparing the unique ID of the event block object that a publisher, such as publishing device 1022, attached to the event block object with the event block ID received by the subscriber.

In an operation 916, a determination is made concerning whether or not processing is stopped. If processing is not stopped, processing continues in operation 910 to continue receiving the one or more event streams containing event block objects from the, for example, one or more network devices. If processing is stopped, processing continues in an operation 918. In operation 918, the started projects are stopped. In operation 920, the ESPE is shutdown.

As noted, in some examples, big data is processed for an analytics project after the data is received and stored. In other examples, distributed applications process continuously flowing data in real-time from distributed sources by applying queries to the data before distributing the data to geographically distributed recipients. As noted, an event stream processing engine (ESPE) may continuously apply the queries to the data as it is received and determines which entities receive the processed data. This allows for large amounts of data being received and/or collected in a variety of environments to be processed and distributed in real time. For example, as shown with respect to FIG. 2, data may be collected from network devices that may include devices within the internet of things, such as devices within a home automation network. However, such data may be collected from a variety of different resources in a variety of different environments. In any such situation, embodiments of the present technology allow for real-time processing of such data.

Aspects of the present disclosure provide technical solutions to technical problems, such as computing problems that arise when an ESP device fails which results in a complete service interruption and potentially significant data loss. The data loss can be catastrophic when the streamed data is supporting mission critical operations, such as those in support of an ongoing manufacturing or drilling operation. An example of an ESP system achieves a rapid and seamless failover of ESPE running at the plurality of ESP devices without service interruption or data loss, thus significantly improving the reliability of an operational system that relies on the live or real-time processing of the data streams. The event publishing systems, the event subscribing systems, and each ESPE not executing at a failed ESP device are not aware of or effected by the failed ESP device. The ESP system may include thousands of event publishing systems and event subscribing systems. The ESP system keeps the failover logic and awareness within the boundaries of out-messaging network connector and out-messaging network device.

In one example embodiment, a system is provided to support a failover when event stream processing (ESP) event blocks. The system includes, but is not limited to, an out-messaging network device and a computing device. The computing device includes, but is not limited to, a processor and a computer-readable medium operably coupled to the processor. The processor is configured to execute an ESP engine (ESPE). The computer-readable medium has instructions stored thereon that, when executed by the processor, cause the computing device to support the failover. An event block object is received from the ESPE that includes a unique identifier. A first status of the computing device as active or standby is determined. When the first status is active, a second status of the computing device as newly active or not newly active is determined. Newly active is determined when the computing device is switched from a standby status to an active status. When the second status is newly active, a last published event block object identifier that uniquely identifies a last published event block object is determined. A next event block object is selected from a non-transitory computer-readable medium accessible by the computing device. The next event block object has an event block object identifier that is greater than the determined last published event block object identifier. The selected next event block object is published to an out-messaging network device. When the second status of the computing device is not newly active, the received event block object is published to the out-messaging network device. When the first status of the computing device is standby, the received event block object is stored in the non-transitory computer-readable medium.

Certain aspects and features of the present disclosure relate to automatically predicting demand for an item for which there is little or no existing information about demand. An example of the item can include a new product that has not yet been sold, or has been sold for a limited period of time. In some examples, a computing device can determine attributes (e.g., type, size, shape, color, weight, material, manufacturer, etc.) of the item. The computing device can use multiple magnitude-pattern classifiers to determine potential magnitude-patterns of demand for the item based on the attributes of the item. The computing device can use a first ensemble methodology (e.g., a neural network) to select an appropriate magnitude-pattern of demand for the item from among the potential magnitude-patterns of demand. Additionally or alternatively, the computing device can use multiple volume classifiers to determine potential volumes of demand for the item based on the attributes of the item. The computing device can use a second ensemble methodology to select an appropriate volume of demand for the item from among the potential volumes of demand. In some examples, the computing device can use the selected magnitude-pattern of demand and the selected volume of demand to generate an initial indication of interest in the item. The initial indication of interest can estimate what demand for the item would have been during a prior time period.

Some examples that use multiple magnitude-pattern classifiers to determine potential magnitude-patterns of demand, and the first ensemble methodology to select an optimal magnitude-pattern of demand, may provide a more robust and accurate initial indication of interest. For example, some pattern classifiers may provide inaccurate results based on the number, type, and combination of attributes provided to the pattern classifiers or other information available to the pattern classifiers. But using multiple pattern-classifiers can help ensure that at least one acceptable result is provided to the first ensemble methodology. The first ensemble methodology can then select the optimal magnitude-pattern of demand from among the potential magnitude-patterns of demand. Likewise, some examples that use multiple volume classifiers to determine potential volumes of demand, and the second ensemble methodology to select an optimal volume of demand, may provide a more robust and accurate initial indication of interest.

In some examples, the computing device can automatically tune or train the pattern classifiers and volume classifiers using existing time series data associated with other items. For example, the time series data can include multiple time series, with each time series being associated with a different item. The computing device can categorize the time series into groups based on the magnitude-patterns of time series, so that time series having similar magnitude-patterns are grouped together. The computing device can also analyze the time series groups to determine common attributes of items included in each group. The computing device can use the time series groups and the respective attributes associated with each group to train the pattern classifiers. Additionally or alternatively, the computing device can categorize the time series into groups based on the volumes of demand of the time series, so that time series having similar volumes of demand are grouped together. The computing device can use the volume groups and the respective attributes associated with each group to train the volume classifiers. In some examples, the computing device can use the outputs from the pattern classifiers to tune the first ensemble methodology and the outputs from the volume classifiers to tune the second ensemble methodology.

Some examples of the present disclosure can automatically retrieve existing time series data and tune the pattern classifiers, volume classifiers, first ensemble methodology, and second ensemble methodology. Thereafter, the initial indication of interest can be automatically generated. This can reduce or eliminate the time consuming, expensive, subjective, labor intensive, and difficult manual processes typically associated with generating an initial indication of interest for an item for which there is little or no existing information about demand.

In some examples, the computing device can use the initial indication of interest as historical data for the item. The computing device can provide the historical data to an application for predicting future interest in the item over a future period of time. The computing device can use the application can generate the prediction of future interest in the item, which can be referred to as an indication of interest in the item over a future time period.

In some examples, the item can be launched (e.g., introduced, new campaign, sold, distributed, downloaded, streamed, or transmitted over a computer network). Thereafter, the computing device can receive data associated with the actual demand for the item since the item launched. The data can be in the form of a time series. The computing device can add the data to the historical data to generate updated historical data. The computing device can use the application to analyze the updated historical data and generate an updated and dynamic prediction of future interest in the item. In some examples, the application can select a predictive model to use from among multiple available predictive models based on the characteristics of the historical data. The application can then generate the updated prediction of future interest in the item using the selected predictive model.

FIG. 11 is a flow chart of an example of a process for tuning a system for use in automatically generating indications of interest in an item according to some aspects. Some examples can include more, fewer, or different operations than the operations depicted in FIG. 11. Also, some examples can implement the operations of the process in a different order. Some examples can be implemented using any of the systems and processes described with respect to FIGS. 1-10.

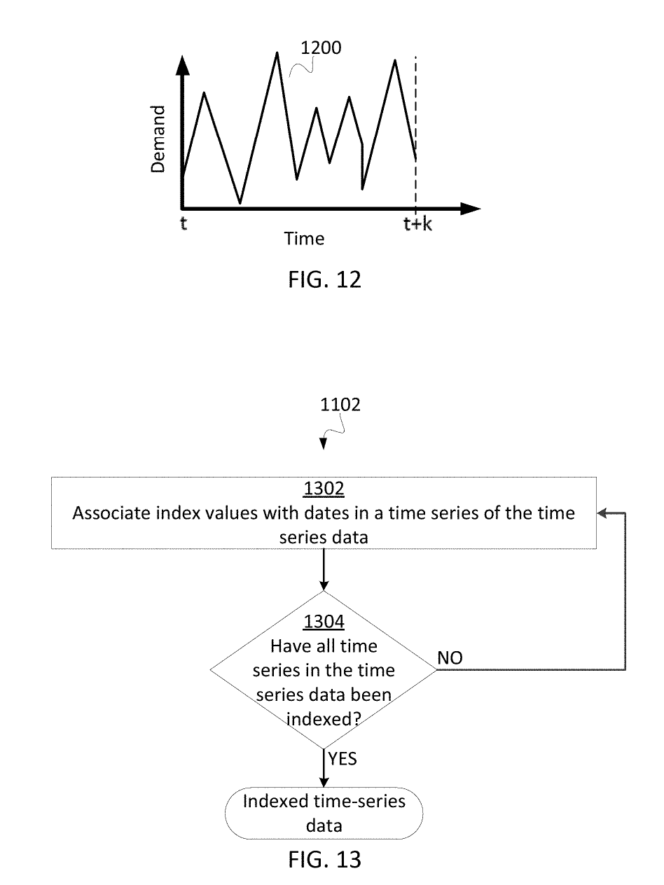

The process described with respect to FIG. 11 can be implemented using time series data. The time series data can include a group of time series. Each time series in the group can represent interest in (e.g., demand for, sales of, use of, downloads or streams of) a particular item, such as a particular product, over a time period. For example, each time series in the group can indicate sales of a particular car over a particular time period. One example of a time series is shown in FIG. 12, in which line 1200 indicates demand for an item between the time period t and t+K.

In block 1102, a processor pre-processes the time series data. In some examples, the processor can determine a time interval (e.g., hours, days, or weeks) that is suitable for analyzing the time series in the time series data. For example, the processor can receive user input indicating the time interval. The processor can extract data within the time interval from some or all of the time series in the time series data. The processor can then use the extracted data as the time series data. Additionally or alternatively, the processor can preprocess the time series data by performing one or more operations shown in FIG. 13.

In block 1302, the processor associates index values with dates in a time series. For example, the processor can associate an index number of one with a date in the time series in which an item is first launched (e.g., first sold, first downloaded, or first streamed). The processor can then associate increasing index numbers with subsequent dates that are at predetermined intervals in the time series. For example, the processor can associate an index number of two with a date that is one week after the launch date; an index number of three with a date that is one week after that; and so on, so that the index numbers are spaced at weekly intervals.

In block 1304, the processor determines if all of the time series in the time series data have been indexed. Because the time series can each have events (e.g., the launch of the item) occurring on different dates, in some examples, indexing the time series can allow for all of the time series to be aligned and compared easily. If the processor determines that all of the time series in the time series data have not been indexed, the processor can select an unindexed time series from the time series data and return to block 1302. Otherwise, the processor can use the indexed time-series data for further processing.

Returning to FIG. 11, in block 1104, the processor performs pattern clustering on the time series data. Pattern clustering can include grouping time series that have similar magnitude patterns together into groups. For example, the processor can analyze the magnitude patterns of two time series during a predetermined time interval (e.g., the time interval determined in block 1102). If the magnitude patterns have similar characteristics, the processor can group the two time series together. Otherwise, the processor can include the time series in different groups. The processor can repeat this process for some or all of the time series to generate multiple magnitude-pattern groups from the time series. In some examples, the processor can use K-means clustering, hierarchical clustering, or both to perform the pattern clustering.

In some examples, the processor can normalize the time series data prior to performing the pattern clustering on the time series data. For example, the processor can normalize the time series so that the magnitudes in the time series are between zero and one. In some examples, the processor can normalize the time series so that all of the magnitudes in the time series sum to a total value of one. Any number and combination of normalization techniques can be used.

In block 1106, the processor can identify attributes associated with a magnitude-pattern group. For example, each magnitude-pattern group can include time series associated with items. Each item can have attributes. Examples of attributes can include a style, color, size, silhouette, fabrication method, manufacturer, distributor, type, shape, make, model, click-stream information, marketing-response data, sentiment data, text-analytics data, video characteristics (e.g., a number of frames in a video or the content of the video), audio characteristics, or any combination of these. The processor can determine similar attributes among some or all of the items in a particular magnitude-pattern group. For example, the processor can access a database that includes items mapped to attributes of the items. The processor can use the database to determine the attributes associated with each item in the magnitude-pattern group. As another example, the processor can use regression analysis, a least absolute shrinkage and selection operator (LASSO) method, stepwise selection, or any combination of these to determine the attributes. In some examples, the processor can identify the attributes that correspond to a predetermined percentage (e.g., 85%) of the items in the magnitude-pattern group. The processor can use those attributes as the attributes for the magnitude-pattern group. In some examples, the processor can repeat this process for some or all of the magnitude-pattern groups.

Additionally or alternatively, the processor can identify attributes associated with a time series in the time series data. For example, some implementations may not include block 1104. In one such implementation, the processor can determine respective attributes associated with some or all of time series in the time series data (e.g., using any of the methods discussed above).

In blocks 1108a-m, the processor tunes pattern classifiers 1-m. The pattern classifiers 1-m can include, for example, a random-forest classifier, a decision tree, a regression model, a neural network, or any combination of these. Some examples can use two or more pattern classifiers 1-m in series or in parallel. In some examples, the processor can provide the magnitude-pattern groups and the corresponding attributes as input to the pattern classifiers 1-m, or otherwise use the magnitude-pattern groups and corresponding attributes, to tune the pattern classifiers 1-m. In other examples, the processor can provide the time series and the corresponding attributes as input to the pattern classifiers 1-m, or otherwise use the time series and corresponding attributes, to tune the pattern classifiers 1-m.

The processor can tune the pattern classifiers 1-m to identify a magnitude pattern to associate with an item (e.g., that has an unknown magnitude pattern) based on the attributes of the item. For example, the processor can tune the pattern classifiers 1-m to identify a particular magnitude-pattern group (or just a particular magnitude pattern) to associate with an item that is red, a car, manufactured by a particular manufacturer, and that has particular features.

In some examples, the pattern classifiers 1-m can identify multiple magnitude patterns, or different magnitude patterns, to associate with an item. For example, the pattern classifier 1 can identify one magnitude-pattern group to associate with the item, while the pattern classifier m can identify another magnitude-pattern group to associate with the item. In some examples, the processor can tune a first ensemble methodology for use in resolving such discrepancies.

In block 1110, the processor tunes the first ensemble methodology. An example of the first ensemble methodology can include a neural network. The processor can tune the first ensemble methodology using the magnitude patterns (or magnitude-pattern groups) identified by the pattern classifiers 1-m. For example, the processor can tune a neural network of the first ensemble methodology by training the neural network using the output from the pattern classifiers 1-m. After tuning the first ensemble methodology, the processor can use the first ensemble methodology to determine an appropriate magnitude pattern for an item based on the output of the pattern classifiers 1-m.

In some examples, the processor can perform operations 1104-1102 before, after, or concurrently to performing operations 1112-1118.

In block 1112, the processor performs volume clustering on the time series data. Volume clustering can include grouping time series that have similar volumes of demand together into groups. For example, the processor can analyze a first time series to determine a first volume of demand during a predetermined time interval (e.g., the time interval determined in block 1102) in the first time series. The processor can analyze a second time series to determine a second volume of demand during the predetermined time interval in the second time series. If the first volume of demand and the second volume of demand are similar, the processor can group the first time series and the second time series together. Otherwise, the processor can include the first time series and the second time series in different groups. In some examples, the processor can use K-means clustering, hierarchical clustering, or both to perform the volume clustering.

In block 1114, the processor can identify attributes associated with a volume group. For example, each volume group can include time series associated with items. Each item can have attributes. Examples of attributes can include a style, color, size, silhouette, fabrication method, manufacturer, distributor, type, shape, make, model, click-stream information, marketing-response data, sentiment data, text-analytics data, video characteristics (e.g., a number of frames in a video or the content of the video), audio characteristics, or any combination of these. The processor can determine similar attributes among some or all of the items in a particular volume group. For example, the processor can access a database (e.g., a file, list, or other arrangement of information that describes attributes of the items) that includes items mapped to attributes of the items. The processor can use the database to determine the attributes associated with each item in the volume group. As another example, the processor can use regression analysis, a least absolute shrinkage and selection operator (LASSO) method, stepwise selection, or any combination of these to determine the attributes. In some examples, the processor can identify the attributes that correspond to a predetermined percentage (e.g., 85%) of the items in the volume group. The processor can use those attributes as the attributes for the volume group. In some examples, the processor can repeat this process for some or all of the volume groups.

Additionally or alternatively, the processor can identify attributes associated with a time series in the time series data. For example, some implementations may not include block 1112. In one such implementation, the processor can determine respective attributes associated with some or all of the time series in the time series data (e.g., using any of the methods discussed above).

In blocks 1116a-n, the processor tunes volume classifiers 1-n. Examples of the volume classifiers 1-n can include a random-forest classifier, a decision tree, a regression model, a neural network, or any combination of these. Some examples can use three or more volume classifiers 1-n in series or in parallel. In some examples, the processor can provide the volume groups and the corresponding attributes as input to the volume classifiers 1-n, or otherwise use the volume groups and corresponding attributes, to tune the volume classifiers 1-n. In other examples, the processor can provide the time series and the corresponding attributes as input to the volume classifiers 1-n, or otherwise use the time series and corresponding attributes, to tune the volume classifiers 1-n.

The processor can tune the volume classifiers 1-n to identify a volume of demand to associate with an item (e.g., that has an unknown volume of demand) based on the attributes of the item. For example, the processor can tune the volume classifiers 1-n to identify a particular volume group (or just a particular volume of demand) to associate with an item that is white, a smartphone, manufactured by a particular manufacturer, and that has particular features.

In some examples, the volume classifiers 1-n can identify multiple volumes of demand, or different volumes of demand, to associate with an item. For example, the volume classifier 1 can identify one volume group to associate with the item, while the volume classifier m can identify another volume group to associate with the item. In some examples, the processor can tune a second ensemble methodology for use in resolving such discrepancies.

In block 1118, the processor tunes the second ensemble methodology. An example of the second ensemble methodology can include a neural network. The processor can tune the second ensemble methodology using the volumes of demand (or volume groups) identified by the volume classifiers 1-n. For example, the processor can tune a neural network of the second ensemble methodology by training the neural network using the output from the volume classifiers 1-n. After tuning the second ensemble methodology, the processor can use the second ensemble methodology to determine an appropriate volume of demand for an item based on the output of the volume classifiers 1-n.

In some examples, the processor can use the tuned pattern classifiers 1-m, first ensemble methodology, volume classifiers 1-n, second ensemble methodology, or any combination of these to predict demand for an item that has an unknown demand (but has known attributes). The item can be a new item that has not yet been sold or downloaded, or that otherwise has little or no history. For example, the item can be a digital media file (e.g., a movie, audio file, e-book, etc.) or a piece of software for which there is little or no existing history (e.g., sales history, download history, click history, user history, or any combination of these).

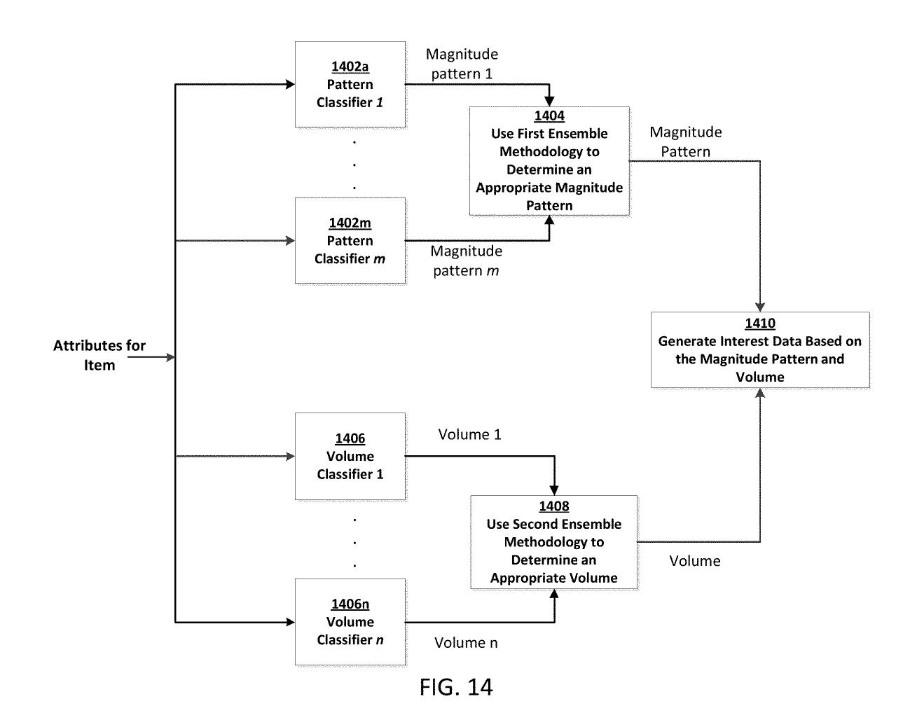

FIG. 14 is a flow chart of an example of a process for automatically generating indications of interest in an item according to some aspects. Some examples can include more, fewer, or different operations than the operations depicted in FIG. 14. Also, some examples can implement the operations of the process in a different order. Some examples can be implemented using any of the systems and processes described with respect to FIGS. 1-10.

The process described with respect to FIG. 14 can be implemented using attributes corresponding to an item. In some examples, the item can have an unknown demand, but known attributes. For example, the item can be a new type of car that has not yet been sold, but that has known attributes. As another example, the item can be a video file, audio file, game file, or a piece of software for which there is little or no existing history. In other examples, the item can have an insufficient amount of history to be able to use traditional predictive modelling methods to predict demand for the item over a future time period. For example, the item can be a new type of car that has only been on sale for three months. In such an example, the limited amount of demand information available about the car may be insufficient for use with traditional predictive modeling methods.

In some examples, the processor can determine the attributes for the item using a database. For example, the processor can access a database that includes items mapped to attributes of the items. The processor can use the database to determine the attributes associated with the item. In other examples, the processor can receive the attributes of the item as user input. For example, the processor can receive user input via a keyboard or touchscreen display. The user input can indicate the attributes of the item.

In blocks 1402a-m, the processor provides the attributes of the item to the pattern classifiers 1-m. For example, the processor can provide the pattern classifiers 1-m with a make, model, name, color, shape, size, manufacturer, company, distributor, material, video characteristic, audio characteristic, software characteristic, software segment, graphical user-interface information, download information, software-usage information, or other attributes related to the item. In some examples, the pattern classifiers 1-m can determine magnitude pattern groups associated with the item based on the attributes of the item. For example, the pattern classifier 1 can determine one magnitude pattern group to associate with the item based on the attributes the item has. The pattern classifier m can determine a different magnitude pattern group to associate with the item based on the attributes of the item. In other examples, the pattern classifiers 1-m can determine magnitude patterns 1-m associated with the item based on the attributes of the item. For example, the pattern classifier 1 can determine one magnitude pattern to associate with the item based on the attributes of the item. The pattern classifier m can determine a different magnitude pattern to associate with the item based on the attributes of the item.

In block 1404, the processor uses the first ensemble methodology to determine an appropriate magnitude pattern to associate with the item. For example, the processor can provide the outputs of the pattern classifiers 1-m to the first ensemble methodology. If the outputs of the pattern classifiers 1-m are all the same, the first ensemble methodology can determine that the outputs are correct and use the outputs as the appropriate magnitude pattern to associate with the item. If the outputs of the pattern classifiers 1-m are different from one another, the first ensemble methodology can determine which of the outputs is correct and use that output as the appropriate magnitude pattern to associate with the item.

In some examples, the processor can perform operations 1402-1404 before, after, or concurrently to performing operations 1406-1408.

In block 1406, the processor provides the attributes of the item to the volume classifiers 1-n. In some examples, the volume classifiers 1-n can determine volume groups associated with the item based on the attributes of the item. For example, the volume classifier 1 can determine one volume group to associate with the item based on the attributes of the item. The volume classifier m can determine a different volume group to associate with the item based on the attributes of the item. In other examples, the volume classifiers 1-n can determine volumes associated with the item based on the attributes of the item. For example, the volume classifier 1 can determine one volume to associate with the item based on the attributes of the item. The volume classifier m can determine a different volume to associate with the item based on the attributes of the item.

In block 1408, the processor uses the second ensemble methodology to determine an appropriate volume of demand to associate with the item. For example, the processor can provide the outputs of the volume classifiers 1-n to the second ensemble methodology. If the outputs of the volume classifiers 1-n are all the same, the second ensemble methodology can determine that the outputs are correct and use the outputs as the appropriate volume of demand to associate with the item. If the outputs of the volume classifiers 1-n are different from one another, the second ensemble methodology can determine which of the outputs is correct and use that output as the appropriate volume of demand to associate with the item.

In block 1410, the processor can generate interest data based on the magnitude pattern (determined in block 1404) and the volume (determined in block 1408). In some examples, the processor can multiply the magnitude pattern by the volume of demand to generate the interest data. The interest data can be time series data that has a magnitude pattern and volume that indicates interest in the item.

In some examples in which the item has not yet been launched, the processor can use the interest data as a prediction of future interest in the item (e.g., a forecast of future interest in the item). Alternatively, in some examples in which the item has been launched but has limited historical data (e.g., the item has only been available online for three months), the processor can include the interest data in the historical data to increase the amount of historical data for the item. The increased amount of historical data can enable the processor to use traditional predictive modeling methods, which may otherwise be unable to be used, on the historical data to predict future interest in the item.

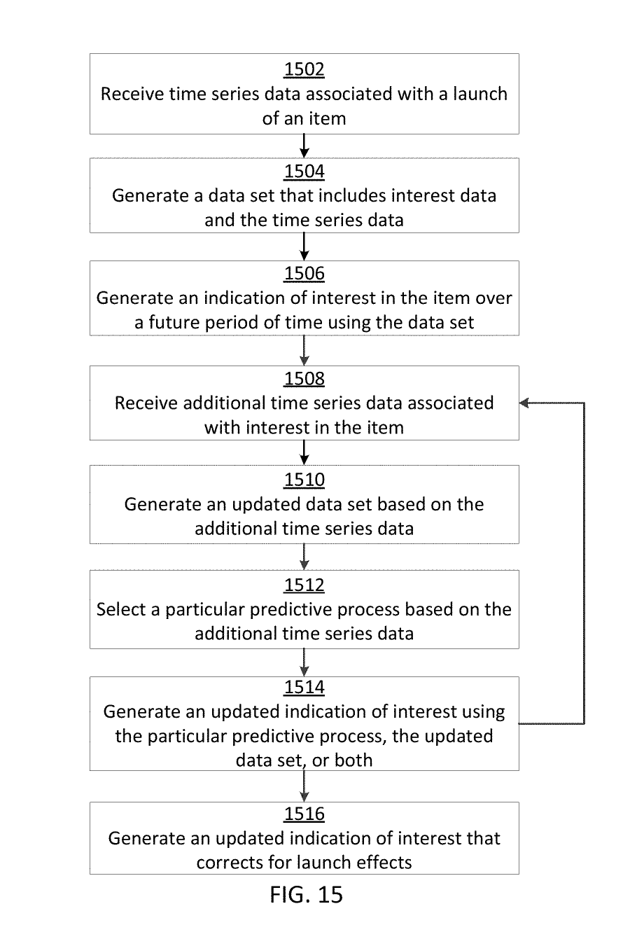

FIG. 15 is a flow chart of an example of a process for automatically generating an indication of interest in an item according to some aspects. Some examples can include more, fewer, or different operations than the operations depicted in FIG. 15. Also, some examples can implement the operations of the process in a different order. Some examples can be implemented using any of the systems and processes described with respect to FIGS. 1-10.

In block 1502, a processor receives time series data associated with a launch of an item. For example, the processor can receive time series data indicating actual demand for the item during the first week or the first two weeks after the item has launched. In some examples, the processor can receive the time series data from a database. In other examples, the processor can receive the time series data as user input.

In block 1504, the processor generates a data set that includes the interest data and the time series data. The processor can generate the data set by including a predetermined amount of the interest data in the data set, including the time series data in the data set, or both of these. For example, the processor can concatenate two seasons worth (e.g., two years' worth) of the interest data together into concatenated data. The processor can then append the time series data at the end of the concatenated data to generate the data set. In some examples, the data set can be used as historical data for the item.

In block 1506, the processor generates an indication of interest in the item over a future period of time (e.g., a forecast of interest in the item) using the data set. For example, the processor can use one or more predictive modeling methods to determine the indication of interest in the item based on the data set. Examples of the predictive modeling methods can include an autoregressive integrated moving average (ARIMA) model, an ARIMAX model, or an exponential smoothing model (ESM).

In some examples, the processor can generate multiple indications of interest in the item (e.g., multiple forecasts) using multiple predictive modeling methods. The processor can then select the best (e.g., most accurate) indication of interest to use. In some examples, the processor can select the best indication of interest by comparing each indication of interest to the time series data (e.g., from block 1502) to determine which indication of interest has values that are closest to the time series data. The processor can additionally or alternatively value the indications of interest using other metrics or parameters that can be preset by an operator.

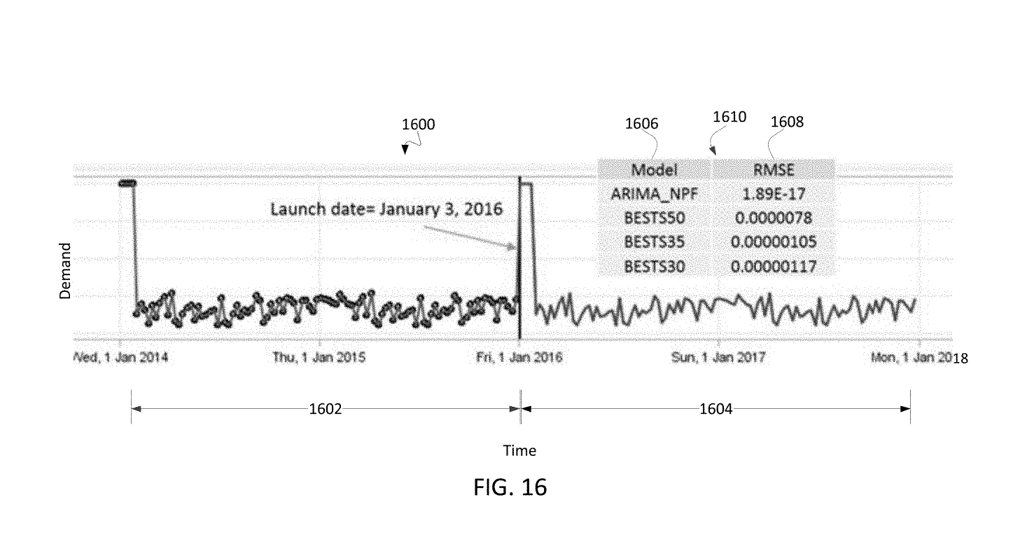

One example of an indication of interest in an item is shown in FIG. 16. Graph 1600 shows the data set 1602 (e.g., historical data) for the item prior to the launch date (of January 3, 2016). Graph 1600 also shows the indication of interest 1604 over the future time period from Jan. 1, 2016 to Jan. 1, 2018. The table 1610 has a first column 1606 showing the different predictive modeling methods (e.g., ARIMA_NPF, BESTS50, BESTS35, and BESTS30) that can be used to generate the indication of interest and a second column 1608 that shows the root mean squared error (RMSE) for each predictive modeling method. The RMSE can indicate the accuracy of the corresponding predictive modeling method.

In block 1508, the processor receives additional time series data associated with interest in the item. For example, with the item being actively sold, the processor can receive data indicating actual sales of the item.

In block 1510, the processor generates an updated data set based on the additional time series data. For example, the processor can incrementally add or append the additional time series data to the end (or beginning) of the data set.

In block 1512, the processor selects a particular predictive modeling method (e.g., predictive process) to use from among multiple available predictive modeling methods based on the additional time-series data. Because some predictive modeling methods can be more accurate with less data and less accurate with more data, and vice-versa, it can be desirable to use certain predictive modeling methods with less data and other predicative modeling methods with more data. Some examples of the present disclosure can allow for the processor to select the best (e.g., most accurate) predictive modeling method to use based on the length of the additional time-series data, the length of the updated data set, or both.

In block 1514, the processor generates an updated indication of interest using the particular predictive modeling method, the updated data set, or both. For example, the processor can use the updated data set with the particular predictive modeling method to generate the updated indication of interest. The updated indication of interest may be more accurate than the initial indication of interest generated in block 1506. For example, the updated indication of interest may be at least partially based on actual data for the item received after launching the item, thereby making the updated indication of interest more accurate.

In some examples, the process can repeat some or all of blocks 1508-1514. For example, the processor can continue to (e.g., automatically) receive additional time series data, update the data set with the additional time series data, select an appropriate predictive modeling method to use, and update the indication of interest using the predictive modeling method.

In some examples, a predictive modeling method can rely on independent variables to generate an indication of interest, such as the updated indication of interest. An independent variable can be a factor that effects one or more characteristics of the indication of interest, which can be referred to as a dependent variable. For example, an ARIMAX model can analyze several independent variables to generate an indication of interest for an item. If the values for these independent variables are left blank or otherwise are inaccurate, the AIRMAX model may provide an inaccurate result. Some examples of the present disclosure can generate values for the independent variables, so that a predictive modeling method can accurately generate an indication of interest for the item. For example, the processor can use a uniform random variable technique to generate a value for an independent variable. Additionally or alternatively, the processor can use a predictive model to generate a value for an independent variable. In some examples, the processor can perform some or all of the operations shown in FIG. 14 to determine values for one or more independent variables. The processor can repeat this process for as many independent variables as necessary. The processor can then use the values for the independent variables with the predictive modeling method to generate the indication of interest.

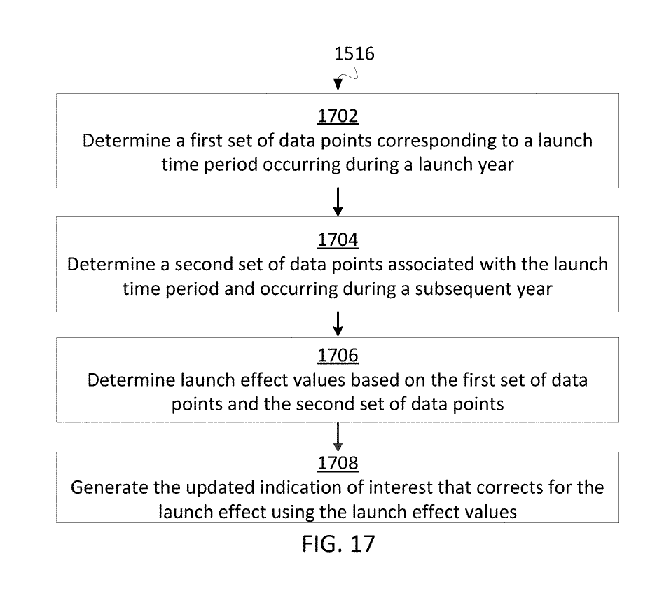

In some examples, the processor can update the indication of interest to correct for an effect of a launch of the item on the indication of interest. The processor can modify or update the indication of interest by performing one or more operations shown in FIG. 17.

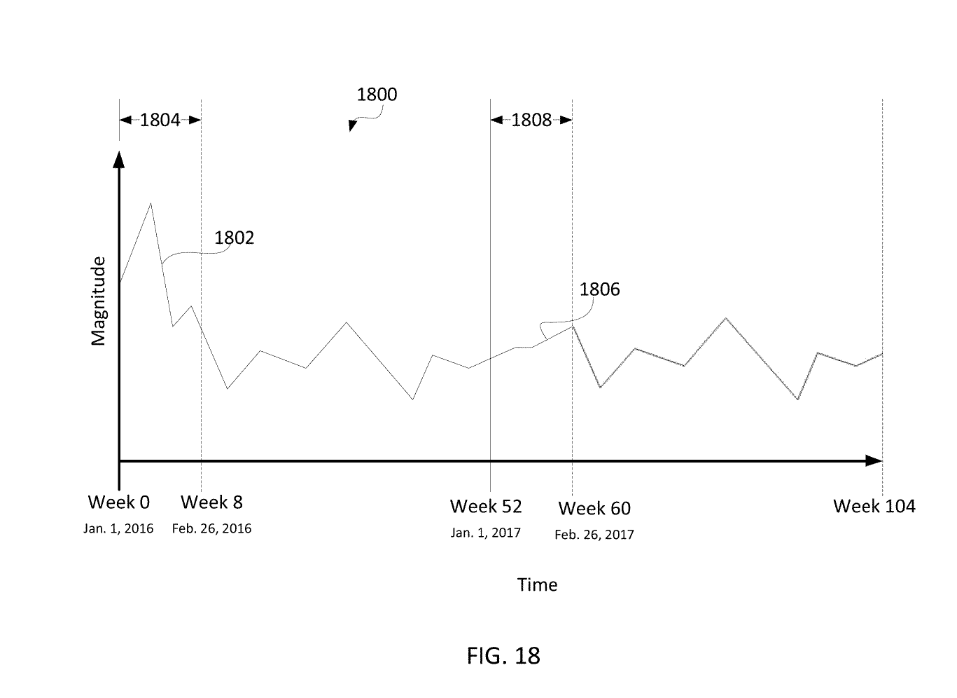

Referring to FIGS. 17-18 together, in block 1702, the processor determines a first set of data points 1802 in interest data 1800 corresponding to a launch time period 1804 occurring during a launch year for an item. The launch year can be the year the item initially launched. In FIG. 18, the launch year can be the year 2016 (e.g., weeks 1-52). The processor can determine the first set of data points 1802 by analyzing the interest data 1800 to determine a portion of the interest data that correspond to the launch time period 1804.

In block 1704, the processor determines a second set of data points 1806 associated with the launch time period 1804 and occurring during a subsequent year. In FIG. 18, the subsequent year can be the year 2017 (e.g., weeks 53-104). For example, the launch time period 1804 can occur between a start date (e.g., Jan. 1, 2016) and an end date (e.g., Feb. 28, 2016) during the launch year (e.g., 2016). The processor can determine the second set of data points 1806 by analyzing a time period 1808 between the same dates (e.g., Jan. 1 and Feb. 28) during the year 2017.

In block 1706, the processor determines launch effect values based on the first set of data points 1802 and the second set of data points 1806. For example, the processor can subtract the second set of data points 1806 from the first set of data points 1802 to determine differences between the two. The differences can be the launch effect values. The differences can represent the effect that the initial launch of the item had on the demand for the item.

In block 1708, the processor generates an updated indication of interest that corrects for the launch effect using the launch effect values. In some examples, the processor can generate the updated indication of interest by subtracting the launch effect values from portions of the indication of interest associated with the launch time period. For example, the processor can subtract the launch effect values from the magnitudes of the data points occurring during the launch time period for every subsequent year after the launch year. As a specific example with reference to FIG. 18, the processor can subtract the launch effect values from the magnitudes of the data points occurring between Jan. 1 and Feb. 26 for every subsequent year after the launch year, 2016.

Some general aspects herein relate to a non-transitory computer readable medium comprising program code executable by a processor for causing the processor to receive attributes of an item for which corresponding data spans a time period that is less than a threshold duration, receive a plurality of time series associated with other items, each time series of the plurality of time series comprising multiple data points arranged in a sequential order over a period of time, and use a first plurality of classifiers to identify a subset of magnitude-pattern groups from a plurality of magnitude-pattern groups based on the attributes, each magnitude-pattern group of the plurality of magnitude-pattern groups including one or more time series of the plurality of time series associated with the other items and having a common magnitude pattern. The program code also cases the processor to use a first ensemble methodology to select a final magnitude-pattern group for the item from the subset of magnitude-pattern groups, use a second plurality of classifiers to determine a subset of interest volumes from a plurality of possible interest volumes based on the attributes, each interest volume of the subset of interest volumes indicating a volume of interest for the item, use a second ensemble methodology to select a final interest volume for the item from the subset of interest volumes, and execute an application to generate interest data based on the final magnitude-pattern group and the final interest volume, the interest data providing an initial indication of interest in the item over a future period of time.

In other aspects, program code executable by the processor can cause the processor to, prior to receiving the attributes associated with the item, use pattern clustering to categorize the plurality of time series associated with the other items into the plurality of magnitude-pattern groups, each time series in the plurality of time series being categorized into a specific magnitude-pattern group of the plurality of magnitude-pattern groups based on a particular pattern of data points in the time series. For each magnitude-pattern group, the processor can determine a plurality of attributes associated with the time series in the respective magnitude-pattern group. The processor can also use the plurality of attributes and the plurality of magnitude-pattern groups to train the first plurality of classifiers to identify one or more magnitude-pattern groups that correspond to item attributes input into the first plurality of classifiers, and tune the first ensemble methodology using results from the first plurality of classifiers.

Prior to receiving the attributes associated with the item, the processor can be caused to use the plurality of attributes and the plurality of time series to train the second plurality of classifiers to determine one or more interest volumes that correspond to item attributes input into the second plurality of classifiers, and tune the second ensemble methodology using results from the second plurality of classifiers. Prior to using the pattern clustering to categorize the plurality of time series, the processor can be caused to for each time series in the plurality of time series, associate a plurality of index values with dates in the respective time series such that a first index value of the plurality of index values correlates to an item launch date and a remainder of the plurality of index values correlate to subsequent dates.

The program code executable by the processor can also cause the processor to use the first ensemble methodology to select the final magnitude-pattern group for the item by: using a first classifier comprising a random-forest classifier to determine a first magnitude-pattern group from the plurality of magnitude-pattern groups based on the attributes; using a second classifier comprising a decision tree to determine a second magnitude-pattern group from the plurality of magnitude-pattern groups based on the attributes; and using the first ensemble methodology to select the final magnitude-pattern group for the item based on the first magnitude-pattern group and the second magnitude-pattern group.

In other aspects, the program code executable by the processor causes the processor to use the second ensemble methodology to select the final interest volume for the item by: using a first classifier comprising a neural network to determine a first interest volume for the item; using a second classifier comprising a random-forest classifier to determine a second interest volume for the item; using a third classifier that utilizes regression analysis to determine a third interest volume for the item; and using the second ensemble methodology to select the final interest volume for the item based on the first interest volume, the second interest volume, and the third interest volume.

The program code also can cause the processor to receive time series data associated with a launch of the item, to generate a data set comprising a predetermined amount of the interest data appended with the time series data, and also to generate an indication of interest in the item over the future period of time from the data set.

In some aspects, the processor can be caused to perform the following operations: determine a first plurality of data points from the predetermined amount of the interest data that corresponds to a launch time period associated with launching the item, the launch time period having a starting date and an ending date during a launch year; determine a second plurality of data points from the predetermined amount of the interest data that corresponds to a subsequent time period during a subsequent year after the launch year that is between the starting date and the ending date; determine launch effect values representing a launch effect by subtracting magnitudes of the second plurality of data points from magnitudes of the first plurality of data points, the launch effect being an effect on interest associated with launching the item; as well as to generate an updated indication of interest that corrects for the launch effect using the launch effect values and the time series data.

The processor can also be caused to receive additional time-series data associated with interest in the item, generate an updated data set by appending the additional time-series data to the data set, select a particular predictive process to use from among a plurality of possible predictive processes based on an amount of the additional time-series data, and generate an updated indication of interest using the particular predictive process and the updated data set. In some optional embodiments, the threshold duration is three months. The threshold can differ in other embodiments.

Other aspects can utilize a computer-implemented method, and/or a system that has a processing device and a memory device in which instructions executable by the processing device are stored for causing the processing device to perform the operations described herein.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

1. A system comprising:
a processing device; and
a memory device in which instructions executable by the processing device are stored for causing the processing device to:
receive attributes of an item, the item having corresponding data that spans a time period that is less than a threshold duration;
receive a plurality of time series associated with other items, each time series of the plurality of time series comprising multiple data points arranged in a sequential order over a period of time;
train at least one classifier in a first plurality of classifiers;
determine, using the first plurality of classifiers, a subset of magnitude-pattern groups from a plurality of magnitude-pattern groups based on the attributes, each magnitude-pattern group of the plurality of magnitude-pattern groups including one or more time series of the plurality of time series associated with the other items and having a common magnitude pattern;
select, using a first ensemble methodology, a final magnitude-pattern group for the item from the subset of magnitude-pattern groups;
determine, using a second plurality of classifiers that is different from the first plurality of classifiers, a subset of demand volumes from a plurality of possible demand volumes based on the attributes, each demand volume of the subset of demand volumes indicating a volume of demand for the item;
select, using a second ensemble methodology, a final demand volume for the item from the subset of demand volumes; and
execute an application to generate forecast data based on the final magnitude-pattern group and the final demand volume, the forecast data indicating demand for the item over a future period of time.

2. The system of claim 1, wherein the memory device further comprises instructions executable by the processing device for causing the processing device to:
prior to receiving the attributes associated with the item:
use pattern clustering to categorize the plurality of time series into the plurality of magnitude-pattern groups, each time series in the plurality of time series being categorized into a specific magnitude-pattern group of the plurality of magnitude-pattern groups based on a particular pattern of data points in the time series;
for each magnitude-pattern group, determine a plurality of attributes associated with the time series in the respective magnitude-pattern group;
train, using the plurality of attributes and the plurality of magnitude-pattern groups, the first plurality of classifiers to identify one or more magnitude-pattern groups that correspond to item attributes input into the first plurality of classifiers; and
tune the first ensemble methodology using results from the first plurality of classifiers.

3. The system of claim 2, wherein the memory device further comprises instructions executable by the processing device for causing the processing device to:
prior to receiving the attributes associated with the item:
train, using the plurality of attributes and the plurality of time series, the second plurality of classifiers to determine one or more demand volumes that correspond to item attributes input into the second plurality of classifiers; and
tune the second ensemble methodology using results from the second plurality of classifiers.

4. The system of claim 2, wherein the memory device further comprises instructions executable by the processing device for causing the processing device to:
prior to using the pattern clustering to categorize the plurality of time series:
for each time series in the plurality of time series, associate a plurality of index values with dates in the respective time series such that a first index value of the plurality of index values correlates to an item launch date and a remainder of the plurality of index values correlate to subsequent dates.

5. The system of claim 1, wherein the memory device further comprises instructions executable by the processing device for causing the processing device to use the first ensemble methodology to select the final magnitude-pattern group for the item by:
using a first classifier to determine a first magnitude-pattern group from the plurality of magnitude-pattern groups based on the attributes;
using a second classifier to determine a second magnitude-pattern group from the plurality of magnitude-pattern groups based on the attributes; and
using the first ensemble methodology to select the final magnitude-pattern group for the item based on the first magnitude-pattern group and the second magnitude-pattern group.

6. The system of claim 1, wherein the memory device further comprises instructions executable by the processing device for causing the processing device to use the second ensemble methodology to select the final demand volume for the item by:
using a first classifier to determine a first interest demand volume for the item;
using a second classifier to determine a second demand volume for the item;
using a third classifier to determine a third demand volume for the item; and
using the second ensemble methodology to select the final demand volume for the item based on the first demand volume, the second demand volume, and the third demand volume.

7. The system of claim 1, wherein the memory device further comprises instructions executable by the processing device for causing the processing device to:
receive time series data associated with a launch of the item;
generate a data set comprising a predetermined amount of the forecast data appended with the time series data; and
generate a forecast indicating interest in the item over the future period of time from the data set.

8. The system of claim 7, wherein the memory device further comprises instructions executable by the processing device for causing the processing device to:
determine a first plurality of data points from the predetermined amount of the forecast data that corresponds to a launch time period associated with launching the item, the launch time period having a starting date and an ending date during a launch year;
determine a second plurality of data points from the predetermined amount of the forecast data that corresponds to a subsequent time period during a subsequent year after the launch year that is between the starting date and the ending date;
determine launch effect values representing a launch effect by subtracting magnitudes of the second plurality of data points from magnitudes of the first plurality of data points, the launch effect being an effect on demand associated with launching the item; and
generate an updated version of the forecast that corrects for the launch effect using the launch effect values and the time series data.

9. The system of claim 7, wherein the memory device further comprises instructions executable by the processing device for causing the processing device to:
receive additional time-series data associated with demand for the item;
generate an updated data set by appending the additional time-series data to the data set;
select a particular predictive process to use from among a plurality of possible predictive processes based on an amount of the additional time-series data; and
generate an updated version of the forecast using the particular predictive process and the updated data set.

10. The system of claim 1, wherein the threshold duration comprises three months.

11. A non-transitory computer readable medium comprising program code executable by a processor for causing the processor to:
receive attributes of an item, the item having corresponding data that spans a time period that is less than a threshold duration;
receive a plurality of time series associated with other items, each time series of the plurality of time series comprising multiple data points arranged in a sequential order over a period of time;
train at least one classifier in a first plurality of classifiers;
determine, using the first plurality of classifiers, a subset of magnitude-pattern groups from a plurality of magnitude-pattern groups based on the attributes, each magnitude-pattern group of the plurality of magnitude-pattern groups including one or more time series of the plurality of time series associated with the other items and having a common magnitude pattern;
select, using a first ensemble methodology, a final magnitude-pattern group for the item from the subset of magnitude-pattern groups;
determine, using a second plurality of classifiers that is different from the first plurality of classifiers, a subset of demand volumes from a plurality of possible demand volumes based on the attributes, each demand volume of the subset of demand volumes indicating a volume of demand for the item;
select, using a second ensemble methodology, a final interest demand volume for the item from the subset of demand volumes; and
execute an application to generate forecast data based on the final magnitude-pattern group and the final demand volume, the forecast data indicating demand for the item over a future period of time.

12. The non-transitory computer readable medium of claim 11, further comprising program code executable by the processor for causing the processor to:
prior to receiving the attributes associated with the item:
use pattern clustering to categorize the plurality of time series associated with the other items into the plurality of magnitude-pattern groups, each time series in the plurality of time series being categorized into a specific magnitude-pattern group of the plurality of magnitude-pattern groups based on a particular pattern of data points in the time series;
for each magnitude-pattern group, determine a plurality of attributes associated with the time series in the respective magnitude-pattern group;
train, using the plurality of attributes and the plurality of magnitude-pattern groups, the first plurality of classifiers to identify one or more magnitude-pattern groups that correspond to item attributes input into the first plurality of classifiers; and
tune the first ensemble methodology using results from the first plurality of classifiers.

13. The non-transitory computer readable medium of claim 12, further comprising program code executable by the processor for causing the processor to:
prior to receiving the attributes associated with the item:
train using the plurality of attributes and the plurality of time series, the second plurality of classifiers to determine one or more demand volumes that correspond to item attributes input into the second plurality of classifiers; and
tune the second ensemble methodology using results from the second plurality of classifiers.

14. The non-transitory computer readable medium of claim 12, further comprising program code executable by the processor for causing the processor to:
prior to using the pattern clustering to categorize the plurality of time series:
for each time series in the plurality of time series, associate a plurality of index values with dates in the respective time series such that a first index value of the plurality of index values correlates to an item launch date and a remainder of the plurality of index values correlate to subsequent dates.

15. The non-transitory computer readable medium of claim 11, further comprising program code executable by the processor for causing the processor to use the first ensemble methodology to select the final magnitude-pattern group for the item by:
using a first classifier comprising a random-forest classifier to determine a first magnitude-pattern group from the plurality of magnitude-pattern groups based on the attributes;
using a second classifier comprising a decision tree to determine a second magnitude-pattern group from the plurality of magnitude-pattern groups based on the attributes; and
using the first ensemble methodology to select the final magnitude-pattern group for the item based on the first magnitude-pattern group and the second magnitude-pattern group.

16. The non-transitory computer readable medium of claim 11, further comprising program code executable by the processor for causing the processor to use the second ensemble methodology to select the final demand volume for the item by:
using a first classifier comprising a neural network to determine a first demand volume for the item;
using a second classifier comprising a random-forest classifier to determine a second demand volume for the item;
using a third classifier that utilizes regression analysis to determine a third demand volume for the item; and
using the second ensemble methodology to select the final demand volume for the item based on the first demand volume, the second demand volume, and the third demand volume.

17. The non-transitory computer readable medium of claim 11, further comprising program code executable by the processor for causing the processor to:
receive time series data associated with a launch of the item;
generate a data set comprising a predetermined amount of the forecast data appended with the time series data; and
generate a forecast indicating interest in the item over the future period of time from the data set.

18. The non-transitory computer readable medium of claim 17, further comprising program code executable by the processor for causing the processor to:
determine a first plurality of data points from the predetermined amount of the forecast data that corresponds to a launch time period associated with launching the item, the launch time period having a starting date and an ending date during a launch year;
determine a second plurality of data points from the predetermined amount of the forecast data that corresponds to a subsequent time period during a subsequent year after the launch year that is between the starting date and the ending date;
determine launch effect values representing a launch effect by subtracting magnitudes of the second plurality of data points from magnitudes of the first plurality of data points, the launch effect being an effect on demand associated with launching the item; and
generate an updated version of the forecast that corrects for the launch effect using the launch effect values and the time series data.

19. The non-transitory computer readable medium of claim 17, further comprising program code executable by the processor for causing the processor to:
receive additional time-series data associated with demand for the item;
generate an updated data set by appending the additional time-series data to the data set;
select a particular predictive process to use from among a plurality of possible predictive processes based on an amount of the additional time-series data; and
generate an updated version of the forecast using the particular predictive process and the updated data set.

20. The non-transitory computer readable medium of claim 11, wherein the threshold duration comprises three months.

21. A method comprising:
receiving, by a processing device, attributes of an item, the item having corresponding data that spans a time period that is less than a threshold duration;
receiving, by the processing device, a plurality of time series associated with other items, each time series of the plurality of time series comprising multiple data points arranged in a sequential order over a period of time;
training, by the processing device, at least one classifier in a first plurality of classifiers;
determining, by the processing device and using a first plurality of classifiers, a subset of magnitude-pattern groups from a plurality of magnitude-pattern groups based on the attributes, each magnitude-pattern group of the plurality of magnitude-pattern groups including one or more time series of the plurality of time series associated with the other items and having a common magnitude pattern;
selecting, by the processing device and using a first ensemble methodology, a final magnitude-pattern group for the item from the subset of magnitude-pattern groups;
determining, by the processing device and using a second plurality of classifiers that is different from the first plurality of classifiers, a subset of demand volumes from a plurality of possible demand volumes based on the attributes, each demand volume of the subset of demand volumes comprising a volume of demand for the item;
selecting, by the processing device and using a second ensemble methodology, a final demand volume for the item from the subset of demand volumes; and
executing, by the processing device, an application to generate forecast data based on the final magnitude-pattern group and the final demand volume, the forecast data indicating demand for the item over a future period of time.

22. The method of claim 21, further comprising:
prior to receiving the attributes associated with the item:
using pattern clustering to categorize the plurality of time series into the plurality of magnitude-pattern groups, each time series in the plurality of time series being categorized into a specific magnitude-pattern group of the plurality of magnitude-pattern groups based on a particular pattern of data points in the time series;
for each magnitude-pattern group, determining a plurality of attributes associated with the time series in the respective magnitude-pattern group;
train, using the plurality of attributes and the plurality of magnitude-pattern groups, the first plurality of classifiers to identify one or more magnitude-pattern groups that correspond to item attributes input into the first plurality of classifiers; and
tuning the first ensemble methodology using results from the first plurality of classifiers.

23. The method of claim 22, further comprising:
prior to receiving the attributes associated with the item:
train, using the plurality of attributes and the plurality of time series, the second plurality of classifiers to determine one or more interest volumes that correspond to item attributes input into the second plurality of classifiers; and
tuning the second ensemble methodology using results from the second plurality of classifiers.

24. The method of claim 22, further comprising:
prior to using the pattern clustering to categorize the plurality of time series:
for each time series in the plurality of time series, associating a plurality of index values with dates in the respective time series such that a first index value of the plurality of index values correlates to an item launch date and a remainder of the plurality of index values correlate to subsequent dates.

25. The method of claim 21, further comprising using the first ensemble methodology to select the final magnitude-pattern group for the item by:
using a first classifier to determine a first magnitude-pattern group from the plurality of magnitude-pattern groups based on the attributes;
using a second classifier to determine a second magnitude-pattern group from the plurality of magnitude-pattern groups based on the attributes; and
using the first ensemble methodology to select the final magnitude-pattern group for the item based on the first magnitude-pattern group and the second magnitude-pattern group.

26. The method of claim 21, further comprising using the second ensemble methodology to select the final interest volume for the item by:
using a first classifier to determine a first demand volume for the item;
using a second classifier to determine a second demand volume for the item;
using a third classifier to determine a third demand volume for the item; and
using the second ensemble methodology to select the final demand volume for the item based on the first demand volume, the second demand volume, and the third demand volume.

27. The method of claim 21, further comprising:
receiving time series data associated with a launch of the item;
generating a data set comprising a predetermined amount of the forecast data appended with the time series data; and
generating a forecast indicating interest in the item over the future period of time from the data set.

28. The method of claim 27, further comprising:
determining a first plurality of data points from the predetermined amount of the forecast data that corresponds to a launch time period associated with launching the item, the launch time period having a starting date and an ending date during a launch year;
determining a second plurality of data points from the predetermined amount of the forecast data that corresponds to a subsequent time period between the starting date and the ending date during a subsequent year after the launch year;
determining launch effect values representing a launch effect by subtracting magnitudes of the second plurality of data points from magnitudes of the first plurality of data points, the launch effect being an effect on demand associated with launching the item; and
generating an updated version of the forecast that corrects for the launch effect using the launch effect values and the time series data.

29. The method of claim 27, further comprising:
receiving additional time-series data associated with demand for in the item;
generating an updated data set by appending the additional time-series data to the data set;
selecting a particular predictive process to use from among a plurality of possible predictive processes based on an amount of the additional time-series data; and
generating an updated version of the forecast using the particular predictive process and the updated data set.

30. (canceled)

31. The system of claim 1, wherein the memory device further includes instructions executable by the processing device for causing the processing device to train the at least one classifier by iteratively supplying the at least one classifier with training data that includes input data, the training data being usable by the at least one classifier to determine a relationship between the input data and output data from the at least one classifier.
